(19) United States
(12) Patent Application Publication
(10) Pub. No.: US 2005/0160458 A1
(43) Pub. Date: Jul. 21, 2005

(54) Interactive television system with custom video-on-demand menus based on personal profiles

(75) Inventor: Joseph P. Baumgartner, Tulsa, OK (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: UNITED VIDEO PROPERTIES, INC., Tulsa, OK (US)

(21) Appl. No.: 10/762,958

(22) Filed: Jan. 21, 2004

(51) Int. Cl. H04N 5/445; G06F 3/00; H04N 7/10; H04N 7/025; H04H 9/00; H04N 7/16; G06F 13/00

(52) U.S. Cl. 725/46; 725/45; 725/9; 725/35; 725/58

(57) ABSTRACT

An interactive television system is provided in which a user can use an interactive television application to access and request media-on-demand programming. The interactive television application may display customized interface display screens that include video-on-demand programs and categories that may be of particular interest to the user. These programs and categories of interest may be based on the user's personal profile. Once a list of programs and categories based on a user's personal profile is generated, one or more of these programs may be incorporated in a menu interface template to generate a video-on-demand menu customized for the user.

### BACKGROUND OF THE INVENTION

This invention relates to television systems, and more particularly, to interactive television systems with video-on-demand capabilities.

Interactive television systems are known to provide interactive television program guide applications. An interactive television program guide application may be configured to provide a number of interactive features such as television program listings, video-on-demand services, web-browsing services, games, home shopping, and other interactive features, to the user.

In a typical interactive television system, the interactive television program guide application is implemented on a set-top box. The user interacts with the interactive television program guide application, for example, to access video-on-demand programming and associated content, using a remote control.

In a computer environment, the user accesses an online interactive television program guide application to obtain desired information such as information associated with video-on-demand programming.

Video-on-demand programs generally consist of a library or database of programs that are available at any time for viewing. Given the potentially large number of available video-on-demand programs, it is difficult to organize these programs in such a manner that a user will easily locate a video-on-demand program of interest.

The majority of current interactive television program guide applications, however, do not generate or display video-on-demand menus that are based on a user's interests. Most current interactive television program guide applications also do not provide an effective way for providing customized video-on-demand menus for video-on-demand programming.

It would therefore be desirable for an interactive television program guide to provide customized menus to a user that list available video-on-demand or audio-on-demand content. For example, it would be desirable to provide a user with video-on-demand menus that list titles, genres or categories of particular interest to the user. It would also be desirable if these customized menus and the titles, genres and categories listed are reflective of the user's interests and likes.

### SUMMARY OF THE INVENTION

In accordance with the present invention, interactive television systems such as interactive television program guide systems may be used to display listings of available video-on-demand (VOD) content offerings. For example, an interactive television program guide may be used to display a list of video-on-demand movies or other programs in the form of a VOD listings screen. The VOD screen may be made up of multiple pages or portions that are accessed by paging or scrolling if desired. A user may access the VOD listings screen by selecting an on-screen menu option on a suitable program guide menu, by pressing a dedicated button on a remote control, or by using other suitable user interface arrangements.

The video-on-demand listings screen may include video-on-demand programs (e.g., movies, television programs, etc.) and categories (e.g., genres, actors, etc.). Given the potentially large number of available programs and categories, some of the listed video-on-demand programs and categories that appear on the menu screen may be drawn from a subset of available programs. In particular, some of the programs and categories may be selected such that they reflect and are based on the user's interest and preferences.

To select programs and categories that may be of interest to a user, a personal profile for the user may be generated based on information related to the user. This personal profile may include information such as the user's demographic characteristics and likes and dislikes (i.e., the user's interests or preferences). The personal profile information may be collected or gathered from public and private records, survey results, etc. The profile may also include information collected or gathered by monitoring the user's interactions with their user equipment and particularly with the user's interactive television program guide. The profile may also be based on information entered directly into the interactive application by the user, such as the user's preferences. These are merely illustrative examples. Any information that may be indicative of the user's interests may be used for creating the user profile. The profile information need not be limited to user attributes that are directly linked to the user's interests. Information may be collected or gathered from multiple sources and combined. For example, information on a user's interests may be collected or gathered indirectly or inferred by making correlations to identify those users with similar profiles and therefore similar interests.

Once a user's personal profile has been generated or otherwise obtained, it may be used to identify media programs and categories that have attributes that match (positively or negatively) the user's profile. In general, programs and categories that positively correlate to the user's profile may be selected as being of possible interest to the user, and vice versa. In addition, correlations may be made between profiles of different users (to identify common programs and categories of interest), as well as between different programs and categories (to identify programs and categories that are similar to those already of interest to the user). This general selecting or filtering may be performed periodically to ensure that the selected programs and categories reflect the current personal profile, as well as currently available video-on-demand programs and categories.

When a list of programs and categories that may be of interest to a user is determined, one or more of these programs and categories may be incorporated into a video-on-demand menu interface template and used to generate a video-on-demand menu that is customized for the user. Because this customization results from the inclusion of programs and categories based on the user's personal profile, when the program guide or other interactive application on the user's equipment displays this menu for the user, the user is more likely to see one or more programs and categories of interest to them, and therefore the user may be more likely to select and order the video-on-demand program.

Multiple users and multiple personal profiles may be accommodated on a single set-top box or other suitable user device. With this type of shared arrangement, each user may identify themselves to the interactive application using a login procedure and personal identification number. After a successful login, the user's personal profile may be used to present the customized video-on-demand menus to the user who has logged in. Alternatively, profiles of multiple users in a household may be combined to identify programs and categories that may be of interest to any or all of combined users, or a single profile may be maintained to reflect the interests of the entire household.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television system in accordance with various embodiments of the present invention.

FIG. 2 is a diagram of illustrative user television equipment in accordance with various embodiments of the present invention.

FIG. 3 is a diagram of additional illustrative user television equipment in accordance with various embodiments of the present invention.

FIG. 4 is a diagram of an illustrative remote control in accordance with various embodiments of the present invention.

FIG. 5 is a diagram of illustrative user computer equipment in accordance with various embodiments of the present invention.

FIG. 6 is a generalized diagram of illustrative user equipment in accordance with various embodiments of the present invention.

FIG. 7 shows an illustrative menu screen in accordance with various embodiments of the present invention.

FIG. 8 shows an illustrative program guide screen in accordance with various embodiments of the present invention.

FIG. 9 is an illustrative display screen showing how a flip banner that contains program listings information for the current channel may be displayed as an overlay over video of the current channel in accordance with various embodiments of the present invention.

FIG. 10 is an illustrative display screen showing how a browse banner that contains program listings information for a channel that may differ from the current channel may be displayed as an overlay over video of the current channel in accordance with various embodiments of the present invention.

FIG. 11 shows an illustrative program guide screen in accordance with various embodiments of the present invention.

FIG. 12 is an illustrative display screen showing how an interactive television application may provide a user with an opportunity to set a program reminder in accordance with various embodiments of the present invention.

FIG. 13 is an illustrative display screen showing how a reminder may be provided for a user in accordance with various embodiments of the present invention.

FIG. 14 is a display screen showing an illustrative video-on-demand menu that may be used to select a category of video-on-demand content in accordance with various embodiments of the present invention.

FIG. 15 is a display screen showing an illustrative video-on-demand menu screen that may be used to locate a desired type of movie in accordance with various embodiments of the present invention.

FIG. 16 shows an illustrative title menu that may be used to select a video-on-demand title of interest in accordance with various embodiments of the present invention.

FIGS. 17a and 17b are illustrative video-on-demand information screens that may be used to access video-on-demand content in accordance with various embodiments of the present invention.

FIG. 18 is an illustrative display screen showing how video-on-demand playback controls may be displayed while video-on-demand content is being displayed for the user in accordance with various embodiments of the present invention.

FIGS. 19a and 19b are illustrative display screens showing how a user's scheduled recordings may be presented and selected in an interactive list in accordance with various embodiments of the present invention.

FIGS. 20a and 20b are illustrative display screens showing how a user's recordings may be presented and selected from an interactive list in accordance with various embodiments of the present invention.

FIG. 21 is an illustrative display screen showing how video for a recording selected from the list of FIG. 20b may be displayed for the user in accordance with various embodiments of the present invention.

FIG. 22 is an illustrative display screen showing how the user may be provided with options that allow the user to schedule a recording of a desired program in accordance with various embodiments of the present invention.

FIG. 23a is an illustrative display screen showing how a user may set parental controls for a given program in accordance with various embodiments of the present invention.

FIG. 23b is an illustrative display screen showing how a user may block content by creating a time-based parental control setting in accordance with various embodiments of the present invention.

FIG. 24 is an illustrative display screen of a customized video-on-demand main menu including video-on-demand program and category options that are based on a user's personal profile in accordance with various embodiments of the present invention.

FIG. 25 is an illustrative display screen of a customized video-on-demand menu with customized video-on-demand program and category options that are based on a user's personal profile in accordance with various embodiments of the present invention.

FIG. 26 is an illustrative display screen of a customized video-on-demand subcategory menu including customized video-on-demand program options that are based on a user's personal profile in accordance with various embodiments of the present invention.

FIG. 27 is an illustrative video-on-demand menu template that may be used to generate a customized video-on-demand menu screen in accordance with various embodiments of the present invention.

FIG. 28 is a flow chart of illustrative steps involved in generating and displaying a customized video-on-demand menu based on a user's personal profile and interests in accordance with various embodiments of the present invention.

### DETAILED DESCRIPTION OF THE PREFERRED EMBODIMENTS

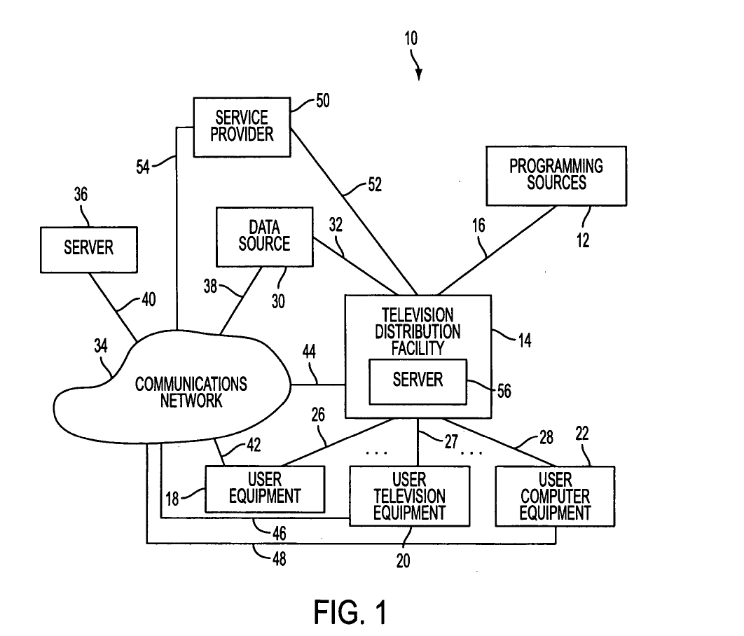

An illustrative interactive television system 10 in accordance with the present invention is shown in FIG. 1. Content such as television programming and other media, such as digital music may be provided from programming sources 12 to television distribution facilities such as television distribution facility 14 using communications path 16. Programming sources 12 may be any suitable sources of television and music programming, such as television and music production studios, etc.

Television distribution facility 14 may be a cable system headend, a satellite television distribution facility, a television broadcast facility, or any other suitable facility for distributing television and music programming to users. There are typically numerous television distribution facilities 14 in system 10, but only one is shown in FIG. 1 to avoid overcomplicating the drawings.

Communications path 16 may be a satellite path, a fiber-optic path, a cable path, or any other suitable wired or wireless communications paths or a combination of such paths.

Television distribution facility 14 may be connected to various user equipment devices 18. Such user equipment 18 may, for example, be located in the homes of users. User equipment 18 may include user television equipment 20 or user computer equipment 22.

The user equipment may receive television and music programming and other information from television distribution facility 14 over communications paths such as communications paths 26, 27, and 28. The user equipment may also transmit signals to television distribution facility 14 over paths 26, 27, and 28. Paths 26, 27, and 28 may be cables or other wired connections, or wireless connections for broadcast or other satellite links.

Data source 30 may include a program listings database that is used to provide the user equipment with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 30 may also be used to provide advertisements (e.g., program guide advertisements and advertisements for other interactive television applications), real-time data such as sports scores, stock quotes, news, weather, etc. Although data source 30 is drawn as an individual box in FIG. 1, data source 30 and the other system components of FIG. 1 may be provided using equipment at one or more locations. Systems components are drawn as single boxes in FIG. 1 to avoid over-complicating the drawings.

Data source 30 may provide program schedule information and other data to television distribution facility 14 over communications path 32 for distribution to the associated user equipment over paths 26, 27, and 28. Communications path 32 may be any suitable communications path such as a satellite communications path or other wireless path, a fiber-optic or other wired communications path, a path that supports Internet communications, a combination of such paths, etc. Data source 30 may provide program schedule information and other data to the user at user equipment 18 over path 38, communications network 34, and path 42. Path 42 may be a wired path such as a telephone line, a cable path, a fiber-optic path, a satellite path, a wireless path, a combination of such paths, or any other suitable path.

User equipment devices such as user television equipment and personal computers may use the program schedule information to display program listings and information on digital music for the user. An interactive television program guide application or other suitable application may be used to display such information on the user's display.

An on-line program guide and other interactive television services may be provided using a server connected to communications network 34 such as server 36. Server 36 may receive program schedule information and other data from data source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access on-line program guide information and other information from server 36 via communications path 42. User equipment 18 may also access the on-line program guide and other services on server 36 via communications path 26, television distribution facility 14, and communications path 44. For example, a cable modem or other suitable equipment may be used by user equipment 18 to communicate with television distribution facility 14. Television distribution facility 14 may communicate with communications network 34 over any suitable path 44, such as a wired path, a cable path, a fiber-optic path, a satellite path, a wireless path, a combination of such paths, etc.

User equipment such as user television equipment 20 and user computer equipment 22 may access the on-line program guide and server 36 using similar arrangements. User television equipment 20 may access the on-line program guide and server 36 using communications path 46 or using path 27, television distribution facility 14, and path 44. User computer equipment 22 may access the on-line program guide and server 36 using communications path 48 or using path 28, television distribution facility 14, and path 44. Paths 46 and 48 may be any suitable paths, such as wired paths, cable paths, fiber-optic paths, satellite paths, wireless paths, a combination of such paths, etc.

Program guide application functions and the functions of other interactive television applications may be supported using server 36 and other servers connected to communications network 34 such as server 56. Interactive television applications may also be supported by servers or other suitable equipment at one or more service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, wireless paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a network-based video recorder or a video-on-demand application may be supported using server 56, server 36, or equipment at service provider 50. Video-on-demand content and video recorded using a network-based video recorder arrangement may be stored on server 56 or server 36 or at service provider 50 and may be provided to the user equipment when requested by users. An interactive television application may be used to support the functions of a personal video recorder (sometimes called a digital video recorder) that is implemented using user equipment 18. Illustrative equipment that may be used to support personal video recorder functions include specialized personal video recorder devices, integrated receiver decoders (IRDs), set-top boxes with integrated or external hard drives, or personal computers with video recording capabilities.

If desired, applications such as the interactive television program guide application, a home shopping application, a home banking application, a video-on-demand application, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, video-on-demand services, home shopping, network-based video recorder functions, personal video recorder functions, navigational functions, program guide functions, communications functions, and other suitable functions may be provided using one application or any other suitable number of applications.

Moreover, the interactive television program guide application, the home banking application, the home shopping application, the network-based video recorder and personal video recorder applications, the video-on-demand application, the gaming applications, communications applications, and navigational applications, are only a few illustrative examples of the types of interactive television applications that may be supported by system 10. Other suitable applications that may be supported include, news services, web browsing and other Internet services, and interactive wagering services (e.g., for wagering on horse races and the like).

The interactive television application or applications that are used in interactive television system 10 may be implemented locally on the user equipment. The applications may also be implemented in a distributed fashion (e.g., using a client-server architecture in which the user equipment serves at least partly and for at least some of the time, as the client and a server such as server 56 at television distribution facility 14, server 36, or other suitable equipment acts as the server. Other distributed architectures may also be used if desired. Moreover, some or all of the interactive television system features of system 10 may be provided using operating system software or middleware software. Such operating system software and middleware may be used instead of or in combination with application-level software. Regardless of the particular arrangement used to implement interactive television features related to program guides, home shopping, home banking, video-on-demand, Internet, communications, etc., the software that supports these features may be referred to as an application or applications.

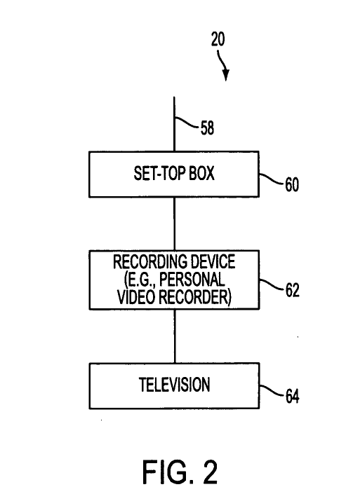

Illustrative user television equipment 20 that is based on a set-top box arrangement is shown in FIG. 2. Input/output 58 may be connected to communications paths such as paths 27 and 46. Input/output functions may be provided by one or more wires or communications paths, but are shown as a single path in FIG. 2 to avoid overcomplicating the drawing. Television programming and other information may be received using input/output 58. Commands and requests and other information from the user may also be transmitted over input/output 58.

Set-top box 60 may be any suitable analog or digital set-top box (e.g., a cable set-top box). Set-top box 60 may contain an analog tuner for tuning to a desired analog television channel. Set-top box 60 may also contain digital decoding circuitry for receiving digital television and music channels. Both analog and digital channels may be handled together if desired. Multiple tuners may be provided (e.g., to handle simultaneous watch and record functions). Set-top box 60 may be an integrated receiver decoder (IRD) that handles satellite television. If desired, set-top box 60 may have circuitry for handling cable, over-the-air broadcast, and satellite content. Set-top box 60 may include a storage device (e.g., a digital storage device such as a hard disk drive) for providing recording capabilities. Set-top box 60 may also be connected to a recording device 62 such as a video cassette recorder, personal video recorder, or other device or devices with storage capabilities.

Set-top box 60 contains a processor (e.g., a microcontroller or microprocessor or the like) that is used to execute software applications. Set-top box 60 may contain memory such as random-access memory for use when executing applications. Nonvolatile memory may also be used (e.g., to launch a boot-up routine and other instructions). Hard disk storage in set-top box 60 or in recording device 62 may be used to back up data and to otherwise support larger databases and storage requirements than may be supported using random-access memory approaches.

Set-top box 60 may have infrared (IR) or other communications circuitry for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a telephone modem, a wireless modem, etc. for communications with other equipment. Such communications may involve the Internet or any other suitable communications networks or paths. If desired, the components of set-top box 60 may be integrated into other user equipment (e.g., a television or videocassette recorder).

Recording device 62 may be used to record videos provided by set-top box 60. For example, if set-top box 60 is tuned to a given television channel, the video signal for that television channel may be passed to recording device 62 for recording on a videocassette, compact disc, digital video disk, or internal hard drive or other storage device. Recording device 62 may have communications circuitry such as a cable modem, an ISDN modem, a DSL modem, a telephone modem, etc. for communications with other equipment. Such communications may involve the Internet or any other suitable communications networks or paths. The components of recording device 62 may be integrated into other user equipment (e.g., a television, stereo equipment, etc.).

Recording device 62 may be controlled using a remote control or other suitable user interface. If desired, video recorder functions such as start, stop, record, etc. and other functions for device 62 may be controlled by set-top box 60. For example, set-top box 60 may control recording device 62 using infrared commands directed toward the remote control inputs of recording device 62 or set-top box 60 may control recording device 62 using other wired or wireless communications paths between box 60 and device 62.

The output of recording device 62 may be provided to television 64 for display to the user. If desired, multiple recording devices 62 or no recording device 62 may be used. If recording device 62 is not present or is not being actively used, the video signals from set-top box 60 may be provided directly to television 64. Any suitable television or monitor may be used to display the video. In the equipment of FIG. 2 and the other equipment of system 10, the audio associated with various video items is typically distributed with those video items and is generally played back to the user as the videos are played.

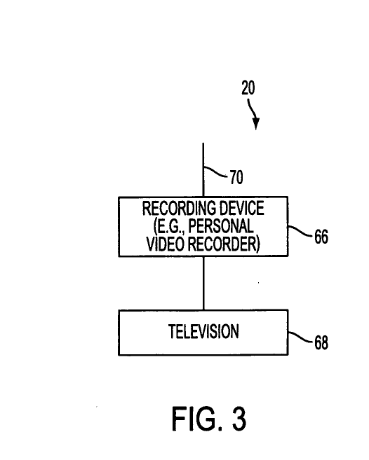

Another illustrative arrangement for user television equipment 20 is shown in FIG. 3. In the example of FIG. 3, user television equipment 20 includes a recording device 66 such as a digital video recorder (e.g., a personal video recorder (PVR)) that uses a hard disk or other storage for recording video or may be a digital video disc recorder, compact disc recorder, videocassette recorder, or other suitable recording device. Equipment 20 of FIG. 3 may also include a television 68. Input/output 70 may be connected to communications paths such as paths 27 and 46. Television programming and other information may be received using input/output 70. Commands and requests and other information from the user may be transmitted over input/output 70.

Recording device 66 may contain at least one analog tuner for tuning to a desired analog television channel (e.g., multiple tuners may be provided). Recording device 66 may also contain digital decoding circuitry for receiving digital television and music channels. If desired, recording device 66 may contain circuitry for handling both analog and digital channels. Recording device 66 also contains a processor (e.g., multiple tuners may be provided, a microcontroller or microprocessor or the like) that is used to execute software applications. Recording device 66 may contain memory such as random-access memory for use when executing applications. Nonvolatile memory may also be used to store a boot-up routine or other instructions. The hard disk and other storage in recording device 66 may be used to support databases (e.g., program guide databases or interactive television application databases). The hard disk or other storage in recording device 66 may also be used to record video such as television programs or video-on-demand content or other content provided to recording device 66 over input/output 70.

Recording device 66 may have IR communications circuitry or other suitable communications circuitry for communicating with a remote control. Recording device 66 may also have dedicated buttons and a front-panel display. The front-panel display may, for example, be used to display the current channel to which the recording device is tuned.

Recording device 66 may also have communications circuitry such as a cable modem, an ISDN modem, a DSL modem, a telephone modem, a wireless modem, etc. for communications with other equipment. Such communications may involve the Internet or other suitable communications networks or paths.

If desired, recording device 66 may include a satellite receiver or other equipment that has wireless communications circuitry for receiving satellite signals.

Recording device 66 of FIG. 3 or recording device 62 of FIG. 2 may record new video while previously recorded video is being played back on television 68 or 64. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing. Recording device 66 and 62 may also be used to allow a user to watch a previously-recorded program while simultaneously recording a new program.

The set-top box arrangement of FIG. 2 and the digital video recorder set-top box arrangement of FIG. 3 are merely illustrative. Other arrangements may be used if desired. For example, user television equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a television or personal computer or other suitable device.

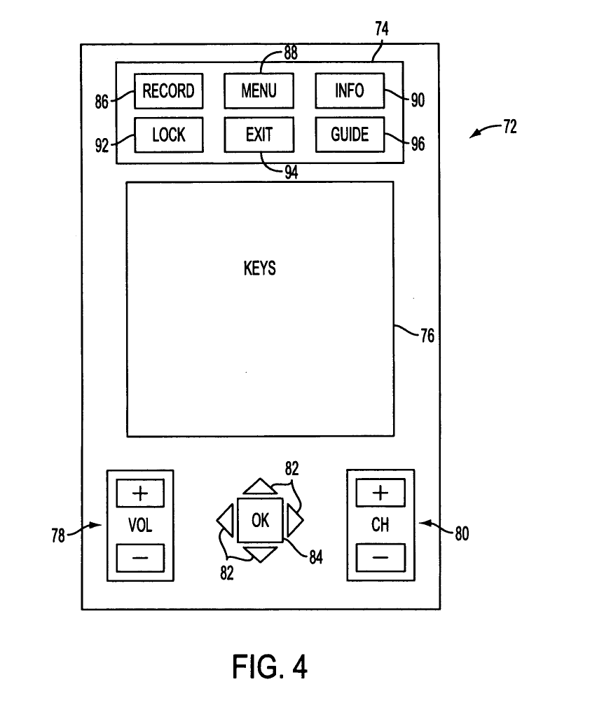

An illustrative remote control 72 for operating user television equipment 20 (or suitable user computer equipment 22) is shown in FIG. 4. Remote control 72 may have function keys 74 and other keys 76 such as keypad keys, power on/off keys, pause, stop, fast-forward and reverse keys, etc. Volume up and down keys 78 may be used for adjusting the volume of the audio portion of a video. Channel up and down keys 80 may be used to change television channels and to access content on virtual channels. Cursor keys 82 may be used to navigate on-screen menus. For example, cursor keys 82 may be used to position an on-screen cursor, indicator, or highlight (sometimes all generically referred to herein as a highlight or highlight region) to indicate interest in a particular option or other item on a screen displayed by the interactive television application.

An OK key 84 (sometimes called a select or enter key) may be used to select on-screen options that the user has highlighted.

Keys 74 may include a record key 86 for initiating recordings. Menu button 88 may be used to direct the interactive television application to display a menu on the user's display screen (e.g., on television 64 or 68 or on a suitable monitor or computer display). Info button 90 may be used to direct the interactive television application to display an information display screen. If the user has highlighted a particular program listing, for example, pressing the info button 90 may direct the interactive television application to provide additional program schedule information related to that program listing (e.g., a program summary, actor information, etc.).

Lock button 92 may be used to modify access privileges. For example, a parent may use lock button 92 or on-screen options to establish parental control settings for the interactive television application. The parental control settings may be time-based settings (e.g., to prevent a child from watching television during a particular time block such as from 3:00 PM to 5:00 PM). The parental control settings may also be used to block programming based on rating, channel, program title, etc. A locked or blocked program is typically not viewable until the interactive television application is provided with a suitable personal identification number (PIN). Once this PIN has been entered, the interactive television program will unlock the user's equipment and allow the locked content to be accessed.

Exit button 94 may be used to exit the interactive television application or to exit a portion of the interactive television application. Guide button 96 may be used to invoke the interactive television program guide.

The keys shown in FIG. 4 are merely illustrative. Other keys or buttons may be provided if desired. For example, a music button may be used to access music with the interactive television application. An edit button may be used to edit stored content (e.g., to remove commercials, remove portions of a video, etc.). Alphanumeric buttons may be used to enter alphanumeric characters. A last or back button may be used to browse backward in the interactive television application (e.g., to return to a previous channel or display screen). Video recorder function buttons such as a play button, pause button, stop button, rewind button, fast-forward button, and record button, may be used to control video recorder functions (local or network-based) in system 10. A help key may be used to invoke help functions such as context-sensitive on-screen help, etc.

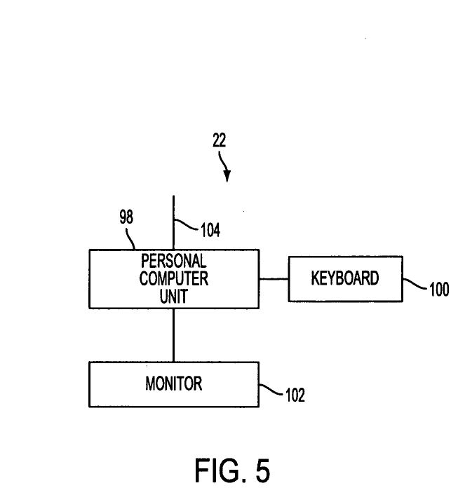

Illustrative user computer equipment 22 is shown in FIG. 5. In the arrangement of FIG. 5, personal computer 98 may be controlled by the user using keyboard 100 or other suitable user input device, such as a trackball, mouse, touch pad, touch screen, voice recognition system, a remote control such as remote control 72 of FIG. 4, etc. Video content such as television programming and interactive television application display screens may be displayed on monitor 102. Television programming, video-on-demand content, video recordings played back from a network-based video recorder, and other information may be received from paths 28 and 48 (FIG. 1) using input/output 104. The user may also send commands and other information used during interactions with the interactive television application and system 10 over input/output line 104.

Personal computer unit 98 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 98 may be used to handle video and other content delivered via input/output line 104 if desired.

Personal computer unit 98 may contain one or more processors (e.g., microprocessors) that are used to run the interactive television application or a portion of the interactive television application.

Storage in personal computer unit 98 such as a hard drive, DVD drive, CD drive, or other suitable storage device or devices may be used to store video and other content. For example, the interactive television application and personal computer unit 98 may use this storage to provide the functions of a personal video recorder.

User equipment 18 such as user television equipment 20 and user computer equipment 22 may be used with network equipment such as server 56, server 36, and equipment at service providers such as service provider 50 of FIG. 1 to provide network-based video recording functions. Video recording functions may be provided by storing copies of television programs and other video content on a remote server (e.g., server 56 or server 36 of FIG. 1) or other network-based equipment such as equipment at a service provider such as service provider 50.

Video recordings may be made in response to user commands that are entered at user equipment 18. In a personal video recorder arrangement, the interactive television application may be used to record video locally on the user equipment in response to the user commands. In a network-based video recorder arrangement, the interactive television application may be used to record video or to make virtual recordings on network equipment such as server 36, 56, or equipment at service provider 50 in response to the user commands. The user commands may be provided to the network equipment over the communications paths shown in FIG. 1. The personal video recorder arrangement and the network-based video recorder arrangement can support functions such as fast-forward, rewind, pause, play, and record.

To avoid unnecessary duplication in a network-based video recorder environment, the system 10 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

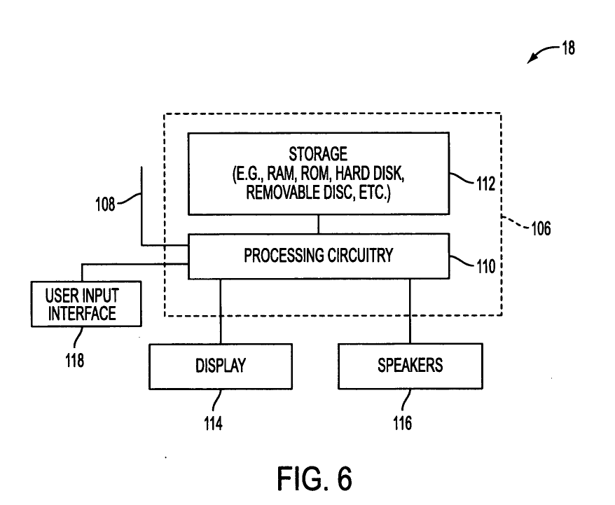

The user television equipment and user computer equipment arrangements described above are merely illustrative. A more generalized embodiment of illustrative user equipment is shown in FIG. 6.

As shown in FIG. 6, control circuitry 106 is connected to input/output 108. Input/output 108 may be connected to one or more communications paths such as paths 26, 27, 28, 42, 46, and 48 of FIG. 1. Television and music programming may be received via input/output 108 (e.g., from programming sources 12, servers or other equipment such as server 36, service providers such as service provider 50, and television distribution facility 14). Program schedule information for an interactive television program guide may be received from data source 30 via input/output 108. Input/output 108 may also be used to receive information from data source 30 for other interactive television applications. The user may use control circuitry 106 to send commands, requests, and other suitable information using input/output 108.

Control circuitry 106 may be based on any suitable processing circuitry 110 such as processing circuitry based on one or more microprocessors, microcontrollers, digital signal processors, programmable logic devices, etc. Memory (e.g., random-access memory and read-only memory), hard drives, DVD drives, CD drives, or any other suitable memory or storage devices may be provided as storage 112 that is part of control circuitry 106. Tuning circuitry such as one or more analog tuners, one or more MPEG-2 decoders or other digital video circuitry, or any other suitable tuning or video circuits or combinations of such circuits may also be included as part of circuitry 106. Encoding circuitry (e.g., for converting over-the-air or cable analog signals to MPEG signals for storage) may also be provided. The tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 114. Display 114 may be a monitor, a television, or any other suitable equipment for displaying visual images. Speakers 116 may be provided as part of a television or may be stand-alone units. Digital music and the audio component of videos displayed on display 114 may be played through speakers 116.

A user may control the control circuitry 106 using user input interface 118. The user input interface 118 may be any suitable user interface, such as a mouse, trackball, keypad, keyboard, touch screen, touch pad, voice recognition interface, remote control, etc.

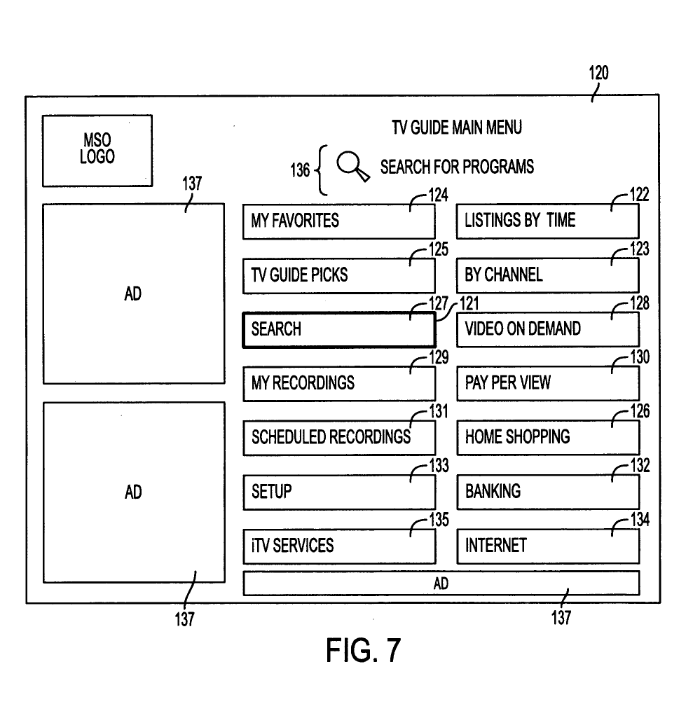

An illustrative menu 120 that may be displayed on the user's display screen is shown in FIG. 7. As shown in FIG. 7, menu 120 may provide the user with an number of selectable options. The options shown in FIG. 7 are merely illustrative. Any suitable options may be provided if desired.

A user of user equipment 18 (e.g., a user of user television equipment 20 or a user of user computer equipment 22, or a user of any other suitable user equipment device) may invoke an interactive television menu such as menu screen 120 by pressing menu button 88 (FIG. 4). Remote control 72 (FIG. 4) or other user interface 118 (FIG. 6) may be used to position highlight region 121 on top of selectable options such as options 122-135. If the user selects option 122 or 123, a screen of program listings may be displayed. Option 124 may be used to display program listings for channels designated by the user as “favorites.” Option 125 may be used to provide program listings selected for promotion by a service provider (e.g., a program guide service provider, a cable operator, etc.). Option 126 may be used to invoke a home shopping service. Options 127 may be used to search program listings by title, time, category, or any other criteria. Option 128 may be selected to display options related to video-on-demand services. Option 129 may be selected to display an interactive list of previously recorded recordings and option 131 may be selected to display an interactive list of programs scheduled for recording. Option 130 may be selected to display pay-per-view program listings and pay-per-view services options. If the user selects option 132, the user may be presented with an opportunity to access home banking functions. Option 133 may be selected to change system setup options and option 134 may be selected to launch a web browser or other application for accessing the Internet. Option 135 may be selected to access other interactive television services. When the user selects an option with highlight region 121 from menu screen 120, the user's selection may be described in information display region 136.

If desired, program guide screens such as menu screen 120 and other interactive television application screens may include selectable advertisements 137. Any suitable advertisements may be provided, including panel advertisements, banner advertisements, advertisements provided between program listings, advertisements provided on certain program listings or other portions of the screen, or any other suitable advertisements. A user may use cursor keys 82 of remote control 72 (FIG. 4) to position a highlight region on an advertisement of interest and may select the highlighted advertisement using OK key 84. Users of other user interfaces may make appropriate selections using the buttons or controls available through those interfaces (e.g., using voice commands if the user interface involves a voice recognition arrangement, etc.).

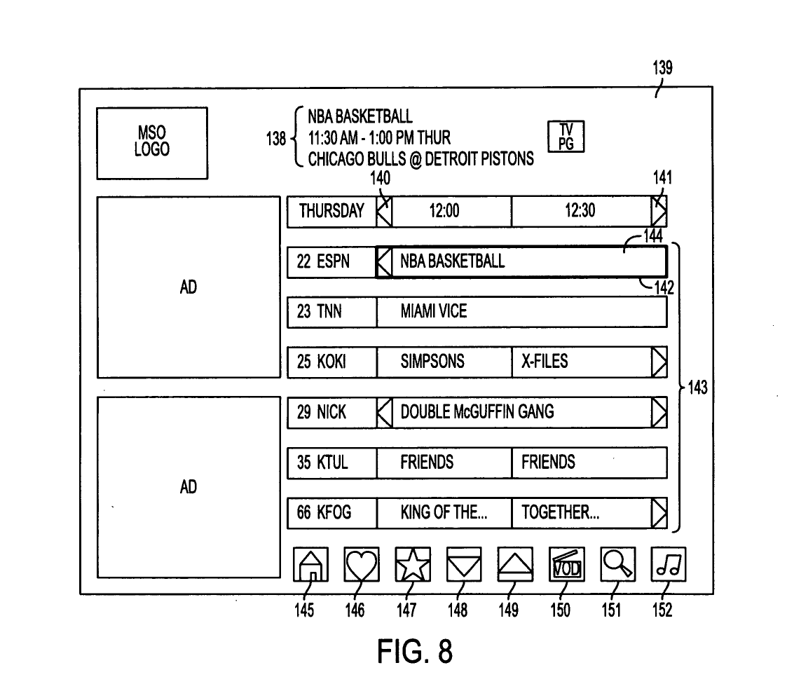

An illustrative program guide screen 138 that may be displayed for the user is shown in FIG. 8. Program guide screen 138 may be displayed, for example, when the user selects program listings option 122 of FIG. 7, when the user selects a suitable option from within an interactive television program guide application or other interactive television application, or when the user presses an appropriate remote control button such as guide button 96 or otherwise uses user input interface 118 to indicate a desire to view program listings.

Program guide screen 138 may contain a grid or list of program listings 143. Program listings 143 may include program titles, channels, scheduled broadcast times, and any other suitable program schedule information. Highlight region 142 may be used to select a desired program listing 144. Program Information for selected programs may appear elsewhere on program guide screen 138 (e.g., in program information display region 139). If the user presses OK key 84 when a program listing for a current program is highlighted, the interactive television application may tune to the channel for that program. If the user presses OK key 84 when a program listing for a future program is highlighted, the interactive television application may provide the user with an opportunity to set a reminder for that program or to record that program.

Other functions that the interactive television application may provide include the ability to set favorites or establish preferences or other settings. For example, the user may select a particular channel for the program guide to automatically tune to when the user equipment is turned on. The user may also select favorite programs, favorite channels, etc. The program guide or other interactive television application may provide the user with the ability to establish parental control settings, the ability to search for programming of interest, and the ability to view program descriptions, advertisements, text, graphics, and video, etc. These are merely illustrative examples of interactive television functions that may be provided by interactive television system 10. Other suitable interactive television functions may be provided if desired.

A user may access program listings (e.g., program listings of the type shown in FIG. 8) by using the interactive television application to select an on-screen option such as option 122 and 123 of FIG. 7, by pressing a dedicated guide button such as guide button 96 on remote control 72, by selecting any other suitable button or on-screen option, etc. In the example of FIG. 8, program listings are currently being displayed for television programs that air between 12:00 noon and 1:00 PM. As shown by arrows 140 and 141, the user may use right or left cursor keys to navigate to other times (e.g., to direct the interactive television application to display appropriate screens of program listings 143 for different time periods). If desired, the user may select options or press keys (or use user input interface 118 to otherwise enter suitable commands) that direct the interactive television application to display program listings organized by channel, by genre, by service type (e.g., pay-per-view or regular broadcast television), etc.

Selectable options, such as options 145, 146, 147, 148, 149, 150, 151, and 152, may be provided as part of program guide screen 138 or any other program guide screen for providing access to various interactive television application features. For example, option 145 may be used to display a home screen or main menu, such as menu screen 120 of FIG. 7. Option 146 may be selected to display program listings for channels designated by the user as “favorites.” Option 147 may be selected to display listings of recommended programs using highlight region 142. Scroll indicators 148 and 149 may be used to navigate down and up through program listings. Option 150 may be selected to display information related to video-on-demand services. Option 151 may be selected to search television program listings by title, time, category, or any other suitable criteria. Option 152 may be selected to display information related to digital music services.

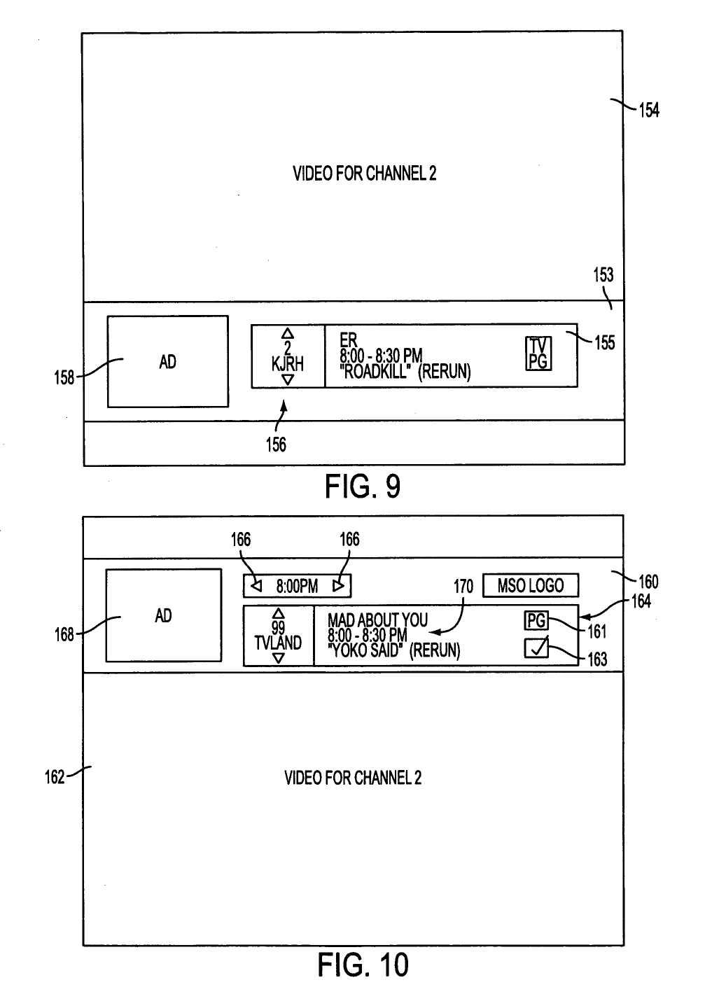

The interactive television application may provide a “flip” tuning feature. As shown in FIG. 9, when the user invokes the flip mode, flip display 153 may be provided over a portion of a channel (i.e., channel 2) that the user is currently tuned to and is watching on display screen 154. Flip display 153 contains information (in region 156) on the program 155 appearing on the current channel (channel 2) to which the set-top box 60 or other user equipment is tuned. The user may change the channel using channel up and down keys on the remote control or using user interface 118 to issue other suitable channel change commands. This simultaneously changes the channel to which the set-top box 60 or other user equipment is tuned and the channel information displayed in region 156 (and the associated program information 155).

The flip display 153 may be removed manually or automatically (e.g., after a few seconds or other suitable time period of user inactivity). When the user starts changing channels again, the flip display 153 may be displayed again.

The flip feature of the interactive television application therefore allows the user to view program information for the channel that the user is currently viewing as the user changes channels. In the example of FIG. 9, the flip display 153 is displayed in the form of an overlay on top of the current channel. If desired, the video for the current channel may be reduced in size and the flip information (e.g., the program title and channel information for the current program) may be displayed at a location on the periphery of the reduced-size video (e.g., at the bottom, side, or top of the reduced-size video).

An advertisement 158 or other content may be provided in the flip display region if desired. Other optional information that may be displayed in flip display 153 includes information on the scheduled broadcast times for the program 155, ratings information, program descriptions, and other program-related information.

The interactive television application may also be used to provide a browse feature. As shown in FIG. 10, when the user invokes the browse feature (e.g., by pressing an up or down cursor key), browse display 160 may be displayed as an overlay over a portion of the channel (i.e., channel 2) that is being displayed on the user's display screen 162 and to which the user is currently tuned. Browse display 160 may initially contain information on the current channel. For example, browse display 160 may, when initially invoked by the user, contain the title of the current program and information on the current channel such as the current channel number, call letters, and network logo.

When the user presses the up or down cursor key (or enters other suitable commands using user interface 118), the browse display may be changed to display information on the programming available on other channels. In the example of FIG. 10, the user has pressed the cursor keys repeatedly, until the user has browsed to channel 99. The video that is being displayed on display screen 162 has not changed in this example (channel 2 is still being displayed).

As indicated by arrows 166, the user may use right and left cursor keys 82 (or other suitable controls) to browse to other time slots (e.g., to view information related to programming that is scheduled for broadcast at a later time). Browse display 160 may contain an advertisement 168, information 170 on scheduled program times, program descriptions and other program-related information and icons such as check icon 163 (to indicate that a reminder has been set for a given program) and ratings icon 161.

If the user locates a currently available program of interest on another channel, the user may press the OK key 84 to direct the interactive television application to tune the user equipment to that channel.

The browse display 160 may be removed manually or may be removed automatically from display screen 162 after a suitable period of user inactivity (e.g., after a few seconds or a minute or two).

If desired, the browse display can be displayed on the periphery of the video for the current program rather than as an overlay. The video for the current channel may be reduced in size accordingly.

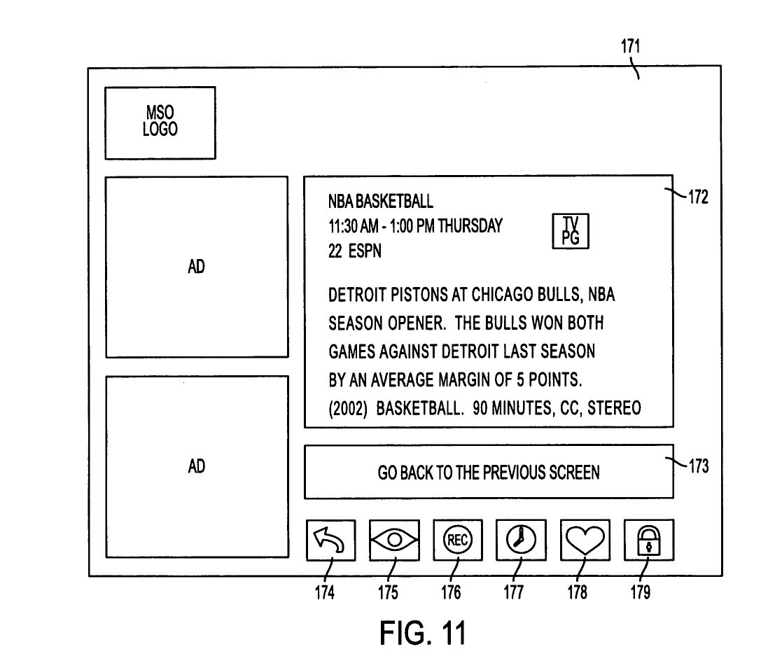

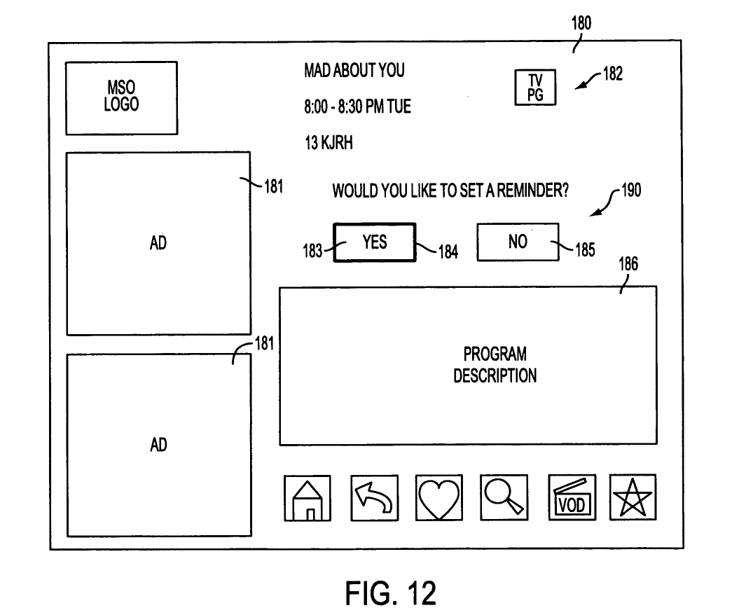

When the user has indicated interest in a program (e.g., by positioning highlight region 142 of FIG. 8 on top of a given program listing, by tuning to a program, by viewing a program listing on the flip banner of FIG. 9 or the browse banner of FIG. 10, etc.), the user may press info key 90 (FIG. 4) to obtain more information for that program. Illustrative info screens 171 and 180 that may be displayed when a user presses info button 90 are shown in FIGS. 11 and 12, respectively. Screens such as screens 171 and 180 may be provided when a user selects a program listing from a interactive television application screen (e.g., program guide screen 138 of FIG. 8). Info screen 171 of FIG. 11 may include a detailed description 172 of a program selected by the user. Description 172 may include, for example, the title, time, channel, and rating of the program, or any other suitable information. As in FIG. 8, selectable options may be provided as part of info screen 171 to provide access to various interactive television application features. For example, option 174 may be used to return to the previous program guide screen. Option 175 may be used to tune to the selected program or set a reminder for the selected program (e.g., the program for which information is displaying in description 172). Option 176 may be selected to display recording options and services for the selected program. Option 177 may be selected to display options for adding a reminder for the selected program. Option 178 may be used to display options for adding the selected program or channel to a user's favorites, and option 179 may be used to display options for providing a parental lock on the selected program. Selectable options for other interactive television application features may also be provided. A highlight region may be used to select any of the selectable options provided by a program guide screen. Information describing a highlighted option may be provided, for example, in information display region 173.

Information screens may include advertisements. For example, info screen 180 of FIG. 12 may include selectable advertisements 181. Information regions on screen 180 such as title region 182 and program description region 186 may be used to display information on the selected program such as title information, ratings information, plot summary information, information about actors, genre, critics ratings, etc.

Region 190 may be used to inform the user of the possibility of setting a reminder for the selected program, of tuning to the channel showing the selected program, of recording the selected program, of purchasing the selected program if it is a pay-per-view program, of parentally controlling the selected program, of configuring a related profile or preference settings, or performing any other suitable action related to the selected program. Region 190 may also be used to provide additional information related to the selected program. The user may position highlight region 184 on top of either yes option 183 or no option 185 or any other suitable options (e.g., options to tune to the channel, to record the program, to purchase the program, to parentally control the program, to configure the preference settings, etc.). When the user presses the OK key 84, the interactive television application may then take appropriate actions. If the user opts to set a reminder for the program listed in the info screen 180, the interactive television application may display a pop-up reminder overlay on top of the video for the channel that the user is currently watching just before the program associated with the reminder is scheduled to begin, or any suitable display screen that is active at the time that the reminder pops up (e.g., a program listings screen).

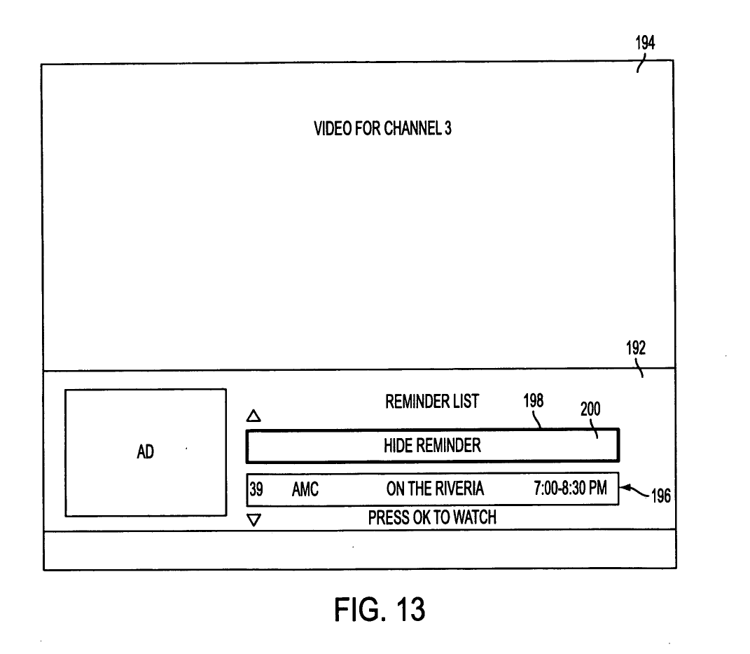

An illustrative reminder is shown in FIG. 13. In the example of FIG. 13, the user is watching channel 3. The current time is 6:58 PM. Previously, the user set a reminder for the program “On The Riviera,” which is scheduled to be shown on channel 39 at 7:00 PM. Because the program for which the user set the reminder is just about to begin, the interactive television application displays reminder list 192 as an overlay on top of the video for channel 3 that is being presented on display screen 194. The reminder list may contain a list of one or more programs for which the user has set reminders. In the example of FIG. 13, one program listing 196 (“On The Riviera”) is displayed.

The user can tune to a program by selecting that program from the reminder list 192. For example, the user may position highlight region 198 on listing 196 and may select that listing by pressing the OK key 84. The interactive television application may then tune the user to the channel for the desired program (i.e., channel 39 in this example).

The user can close the reminder list by pressing the OK key 84 while hide reminder option 200 is highlighted.

The reminder list may be displayed at any suitable time (e.g., at 0-15 minutes before the program of interest is to begin, at a user-selected time before that program, etc.). Moreover, the reminder list may be displayed around the periphery of the video for the current channel and the video for the current channel may be displayed in a reduced-size window. These are merely illustrative examples. Any suitable arrangement may be used to notify the user of upcoming programs or in-progress programs for which the user has set reminders and other programs of interest.

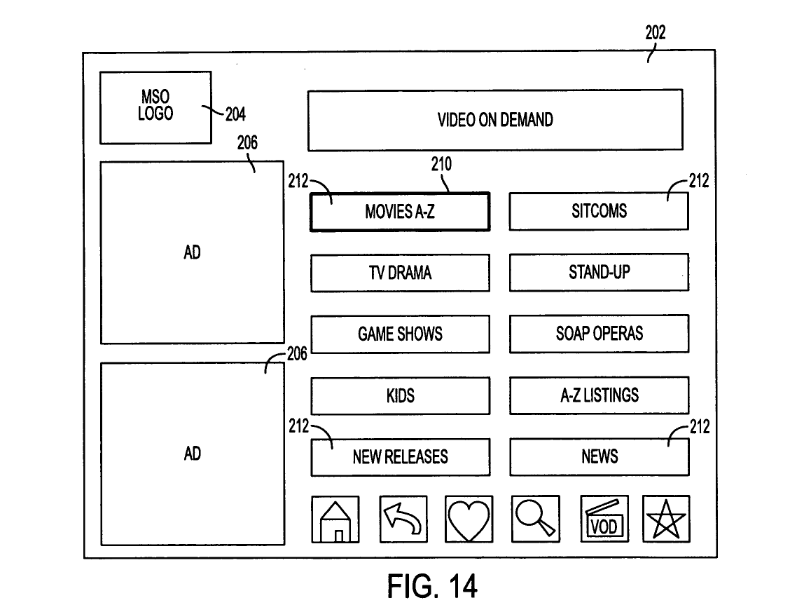

The interactive television application may be used to provide the user with access to video-on-demand content. The user may, for example, be provided with an option such as video-on-demand option 128 on menu screen 120 of FIG. 7. When the user selects option 128, the interactive television application may display a screen such as video-on-demand categories screen 202 of FIG. 14. Screen 202 may include logos such as logo 204, selectable (or non-selectable) advertisements such as advertisements 206, and a screen title 208. The user may position highlight region 210 on an option 212 corresponding to a video-on-demand category of interest.

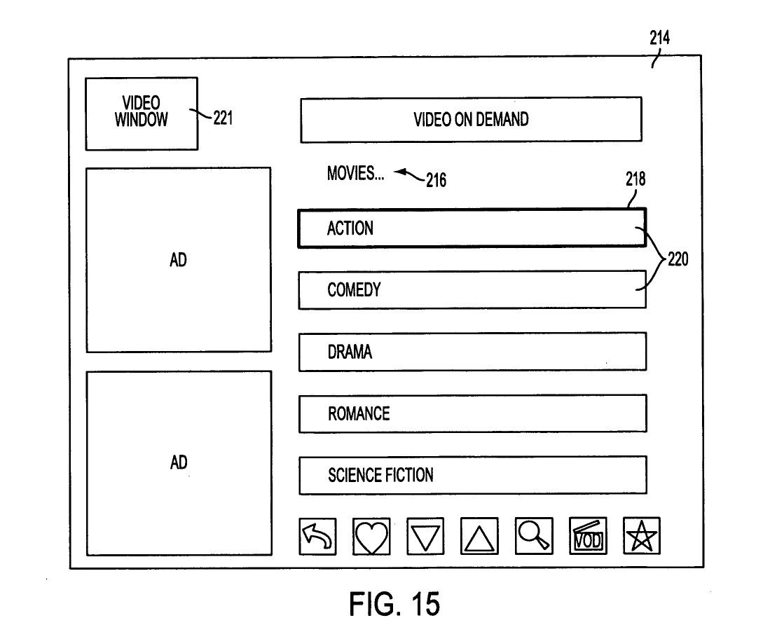

When the user selects the video-on-demand category of interest from screen 202, the interactive television application may display a display screen such as subcategory selection screen 214 of FIG. 15. In the example of FIG. 15, the subcategories screen 214 contains subcategory options 220 corresponding to movies, because (in this example) the user selected movies A-Z option 212 from screen 202 in FIG. 14. Video window 221 may be provided in any video-on-demand information screen and may provide information relating to a video-on-demand program selected by the user or any other suitable video information.

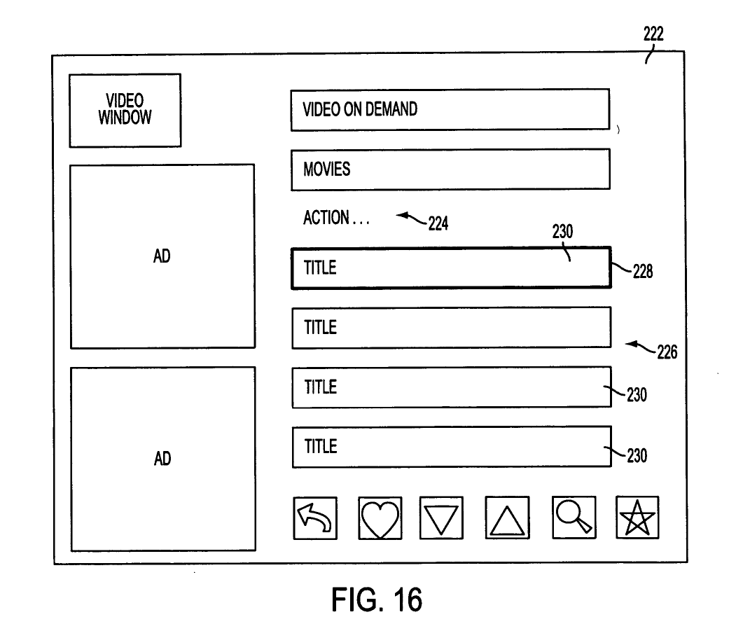

The user may position highlight region 218 onto a desired subcategory 220 and may press OK key 84 to view a list of available video-on-demand content associated with that subcategory. An illustrative display screen 222 that the interactive television application may display for the user when the action subcategory option 220 (FIG. 15) is selected is shown in FIG. 16. As shown in FIG. 16, display screen 222 may include information identifying the selected subcategory 224. Screen 222 may also include a list 226 of titles 230 (or other content indicators). The user may position highlight region 228 on a desired video-on-demand title 230 and may press the OK key to proceed with the selection of that title.

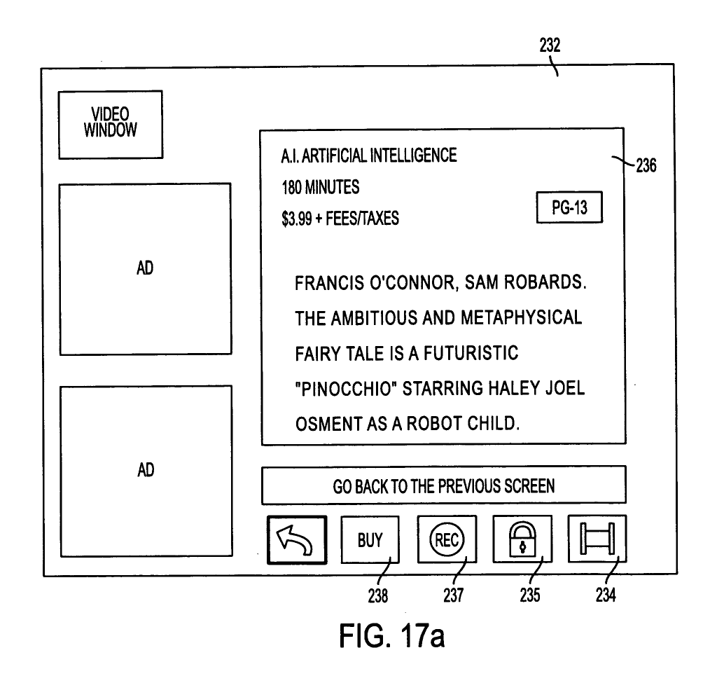

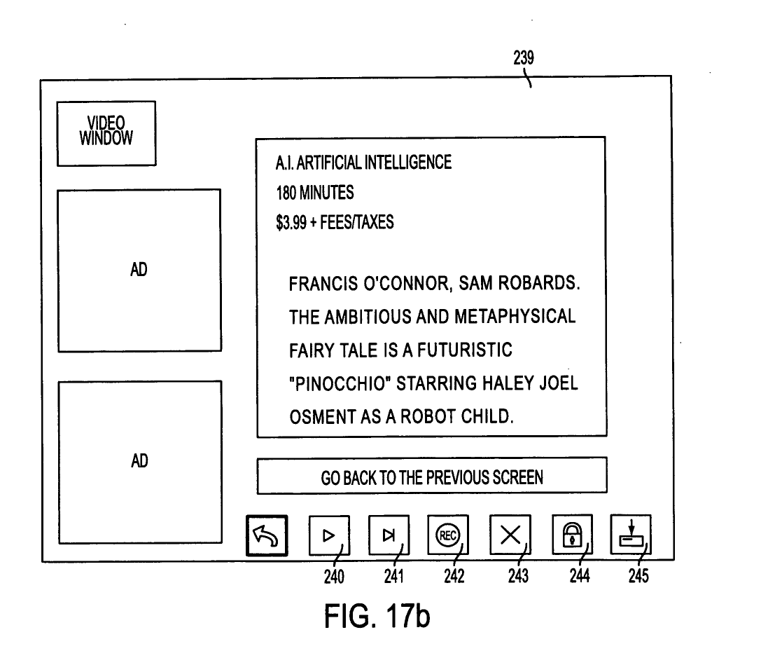

Selecting a desired video-on-demand title 230 from title selection screen 222 may direct the interactive television application to display a video-on-demand information screen such as information screen 232 of FIG. 17a. Screen 232 may include information 236 on the selected video-on-demand content, such as title, run time, price, rating, and a description of the selected video-on-demand content.

Selectable options, such as options 234, 235, 237, and 238 may be provided as part of screen 232 to provide access to various interactive television application features. For example, option 238 may be selected to access options for ordering the selected video-on-demand content. Option 237 may be used to access options for recording the selected content, and option 235 may be used to access options for setting parental control locks for the selected content. If the user selects option 234, the interactive television application may display a video clip containing information on the video-on-demand content of interest (e.g., a promotional video such as a preview, a trailer, a review, etc.) . The video clip may be delivered to the user equipment 18 from a server such as server 36 or server 56 of FIG. 1 or from equipment at a service provider such a service provider 50. The interactive television application may also provide the user with additional information on the video-on-demand content in response to the user selecting option 234. Other suitable selectable options may also be provided on screen 232 (e.g., a program package information and purchase option, options for searching program listings for related content, etc.).

If a user requests information for video-on-demand content that has already been ordered, the interactive television application may provide video-on-demand information screen such as screen 239 of FIG. 17b, which may include selectable options different than those provided for screen 232 of FIG. 17a. For example, option 240 may be used to start playing selected video-on-demand content from the program position most recently viewed. Option 241 may be used to present the selected content from the beginning, and option 242 may be used to access options for recording the content. Option 243 may be used to remove the selected content from a listing of the ordered and available content. Option 244 may be used to access options for setting parental control locks for the selected content. If the selected content is being accessed over a network or being provided by a network storage device, option 245 may be used to store the content on a local storage device.

In response to a user ordering selected content (e.g., by selecting an on-screen order option such as option 238 of FIG. 17a, or by using remote control 72 or any other suitable input device 118 to order content, etc.), the interactive television application may deliver the ordered video-on-demand content to the user equipment from a server such as server 36 or server 56 or from a service provider such as service provider 50. The communications paths and communications network 34 of FIG. 1 may be used in delivering the requested content.

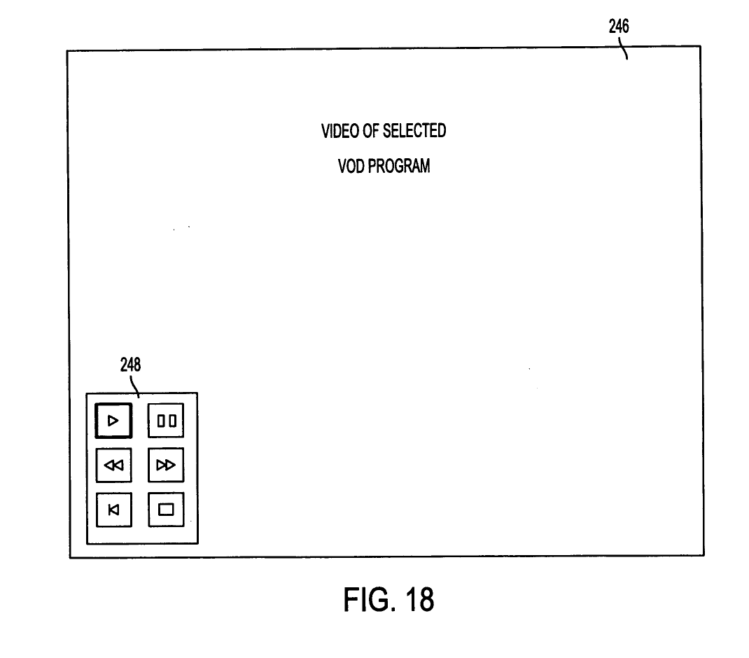

The ordered video-on-demand content may be displayed for the user on a display screen such as video-on-demand playback screen 246 of FIG. 18. As shown in the lower portion of screen 246, interactive options may be displayed in a toolbar 248 or other suitable format. The interactive options 248 (or similar remote control buttons) may allow the user to rewind the video-on-demand content to the beginning, rewind, play, fast-forward, pause, stop delivery of the video-on-demand content, or perform other video playback options. The arrangement of FIG. 18 is merely illustrative. For example, the video-on-demand content may be played back in a reduced size window (of fixed or user-selectable size).

The interactive television system 10 may be used to support video recorder functions. The video recorder functions may be supported using local arrangements (e.g., arrangements in which a personal video recorder or other suitable equipment in the user's home is used to record videos on a local hard drive or other storage device) and network-based arrangements (e.g., arrangements in which network equipment such as servers 36 and 56 or equipment at a service provider such as service provider 50 is used to store video and data for the user). Combinations of these arrangements may also be supported using system 10.

In a local video recorder arrangement (sometimes called a personal video recorder arrangement or local digital video recorder arrangement), video recordings are stored locally on the user equipment. Information on which videos have been recorded may also be maintained locally. Program guide information (e.g., titles, rates, descriptions, categories, etc.) may also be maintained for the recorded videos. When a user desires to view a list of the recordings that the user has stored on the user equipment, the interactive television application may retrieve this information from local storage and may display this information to the user locally on user equipment 18. The user may then select a desired recording to play back.

In a network-based video recorder arrangement (sometimes called a client-server video recorder arrangement), videos may be stored on the network (e.g., at servers such as servers 36 and 56 or at a service provider such as service provider 50). Information on which programs have been recorded for the user may be stored locally and on the network (e.g., at servers such as servers 36 and 56 or at a service provider such as service provider 50).

Network-based recordings may be made in a number of ways. For example, some or all of the regularly-broadcast television programming provided by programming sources 12 may be automatically recorded or copies of this programming otherwise maintained on a suitable network storage device such as server 36, server 56, or equipment at a service provider such as service provider 50. If the user chooses to “record” a program, no actual recording need be made, because a copy of the desired program already exists on the system. With this type of arrangement, virtual recordings take the place of real recordings.

The user may be given a “personal area” on the network. The personal area may be accessed when the user enters an appropriate personal identification number or by virtue of the user's connection to the network through a known or trusted communications path (e.g., when the user is connected through a dedicated cable path to a server at a cable system headend such as a server 56 at television distribution facility 14 of FIG. 1).

The personal area may be used to maintain a list of the video content that the user has recorded. Whenever the user directs the network-based video recorder portion of the interactive television system to make a recording, the system updates the user's personal area to make it appear as though an additional “real” copy of the requested recording has been made. The network-based video recorder implemented with this approach therefore conserves storage space, while providing users with the illusion of access to a network-based video recorder dedicated to their personal use.

Alternatively, there may be no personal area and each user may have access to all previously recorded content to which they had rights when originally broadcast.

As another example, some or all of the content for which a user requests that a recording be made may be recorded by creating actual copies (e.g., digital recordings) of the requested content. These actual copies may be stored on network equipment (e.g., servers such as servers 36 and 56 or equipment at a service provider such as service provider 50).

Programs recorded onto a network server may be copied to a user's local storage.

A combination of these approaches may be used if desired. For example, some content may be automatically retained by the system (e.g., copies of popular programming). The user may make virtual recordings of this material. The presence of the virtual recordings may be reflected in the user's personal area. Other content may be stored in the form of actual recordings at the direction of the user (e.g., less popular content). The presence of these recordings may also be reflected in the user's personal area.

Regardless of the way in which network-based recordings (virtual or real) and local recordings are made, the interactive television application may be used to provide the user with interactive display screens that assist the user in making recordings, managing recordings (e.g., editing recordings, deleting recordings, renaming recordings, sending recordings to other users over the communications paths of FIG. 1, etc.), playing back recordings, viewing information about recorded programs, etc.

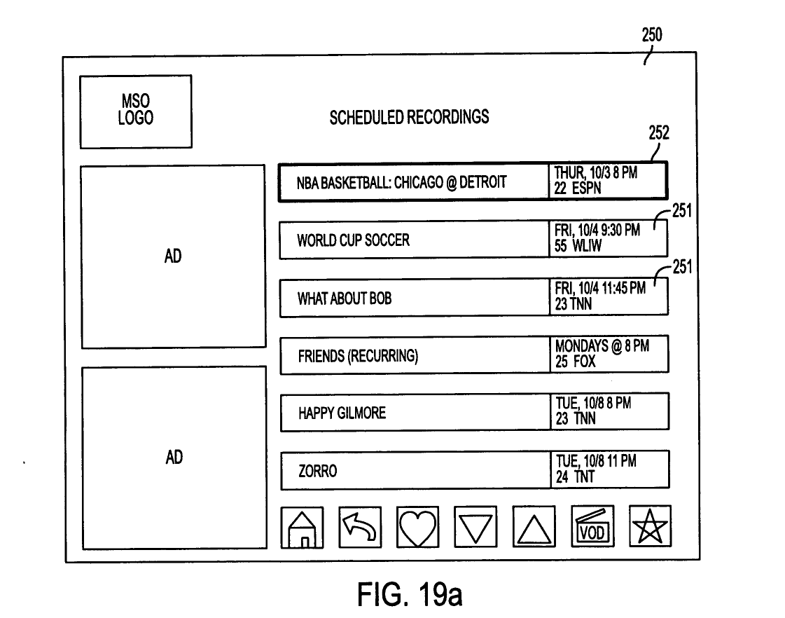

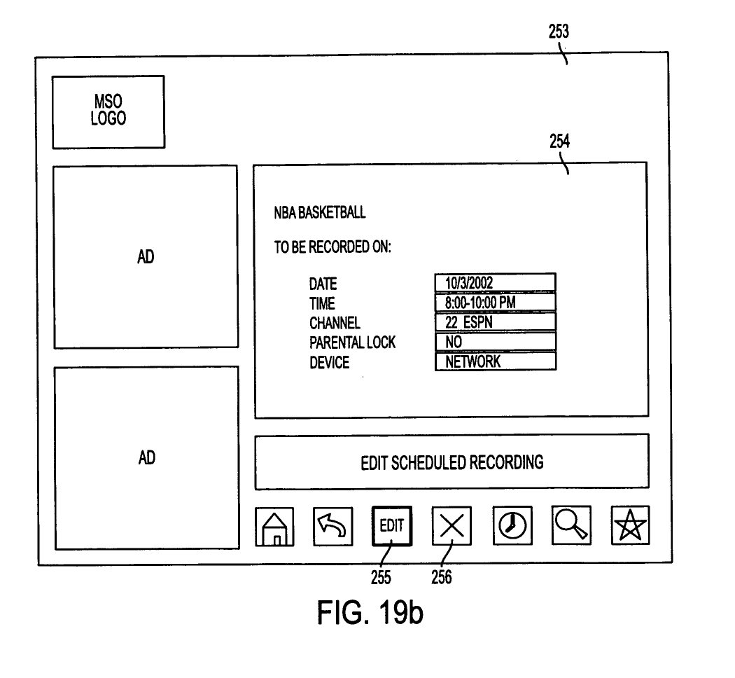

Once a program has been selected by a user for recording, the selected program may be presented in an interactive list of programs scheduled to be recorded. An illustrative scheduled recordings screen 250 that may be displayed for the user on user equipment 18 is shown in FIG. 19a. Screen 250 may be displayed by the interactive television application when the user selects an option provided by another program guide screen, such as program guide screen 120 of FIG. 7 or any other suitable option. Screen 250 may include, for example, a list of programs scheduled to be recorded 251. A highlight region 252 may be used to select a scheduled recording from the list. The user may position highlight region 252 on a desired scheduled recording and select the scheduled recording using an appropriate key of remote control 72.

Information about a scheduled recording. selected by the user may be presented in a screen such as screen 253 of FIG. 19b. Screen 253 may include scheduled recording information 254, which may show the date, time, and channel for which a program is to be recorded. Information 254 may also indicate which device has been designated to record the program and whether a parental lock is set for the program scheduled to be recorded. The user may edit information 254 by selecting edit option 255 using a highlight region. Other selectable options may be provided in screen 253, for example cancel option 256 which the user may select to cancel the scheduled recording.

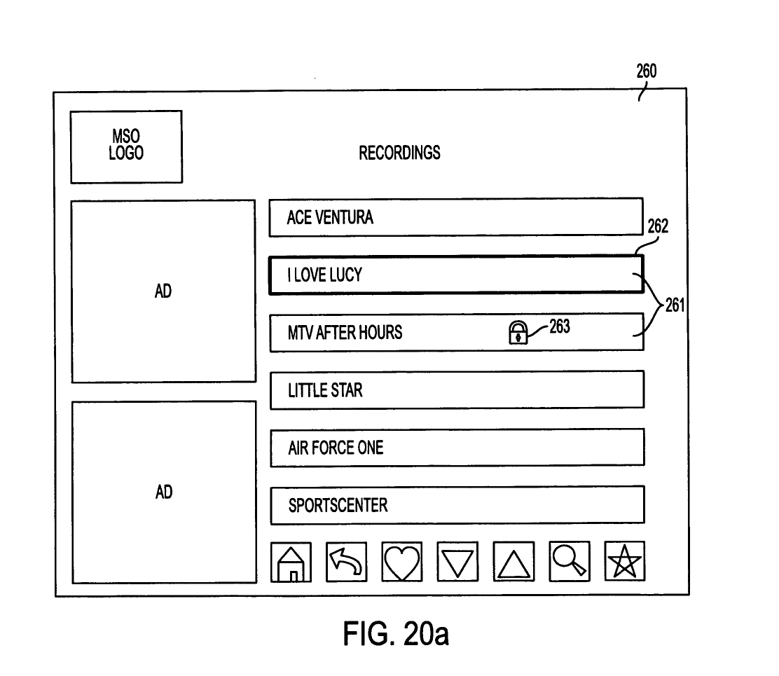

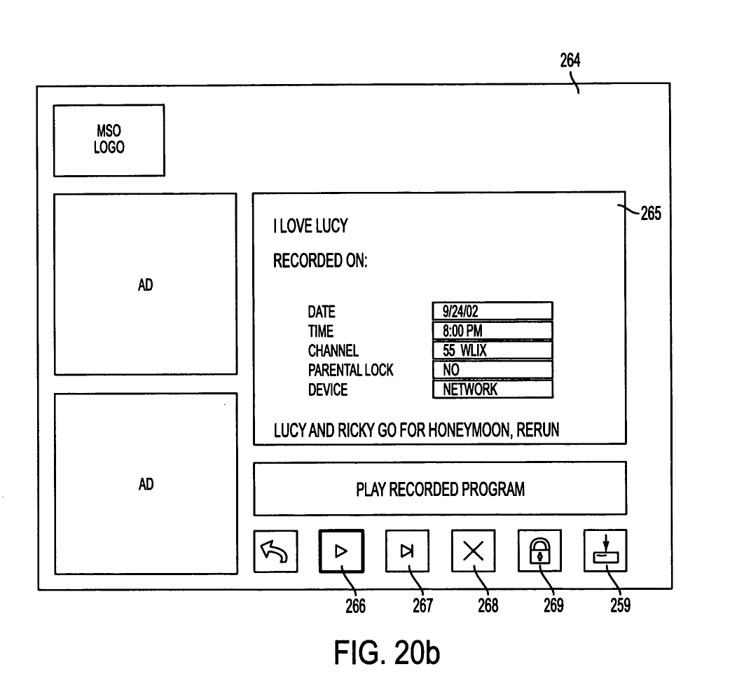

Once a program has been recorded, a program guide screen may be presented to display recorded programs. An illustrative video recordings screen 260 that may be displayed for the user on user equipment 18 is shown in FIG. 20. Screen 260 may be displayed by the interactive television application when the user selects an option provided by another program guide screen, such as program guide screen 120 of FIG. 7 or any other suitable option. The recordings 261 may be local recordings that are stored on the user's equipment 18 or may be real or virtual network-based recordings (e.g., network-based content stored on equipment such as server 36 or server 56 or at service provider 50). In a network-based video recorder environment with a personal area, screens such as screen 260 provide access to all or part of the user's personal area. The user may navigate through the personal area using remote control 72 or other suitable user interface 18.

Screen 260 may include a list of the user's recordings 261. Recording listings may include the time and channel the program was recorded or any other suitable information. The user may position highlight region 262 to select a recording of interest (e.g., to view that recording, to view information about that program, to delete the program, etc.). The user may position highlight region 262 on a desired recording and select the recording using an appropriate key of remote control 72.

Information about a recording selected by the user may be presented in a screen such as screen 264 as illustrated in FIG. 20b. Screen 264 may include recording information 265, which may show the date, time, and channel the program was recorded. Information 265 may also show whether a parental lock is set for the recording and what device has been designated to store the recording. The user may play the recording by selecting option 266. The user may play the selected recording from the beginning by selecting option 267. Option 268 may be selected to delete the recording from the list of recordings. Option 269 may be used to set a parental lock for the selected recording. If the selected recording is being stored on a network video storage device, the user may select option 259 to transfer the recording to a local storage device. On-screen options may be selected using a highlight region and a remote control, or by any other suitable method.

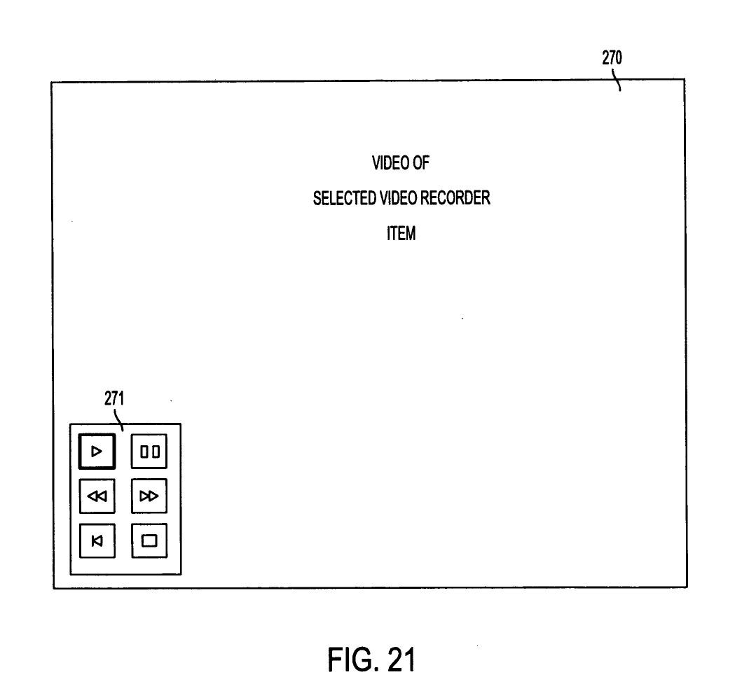

When a given recording is selected for play back, for example by selecting play option 266, a display screen such as display screen 269 of FIG. 21 may be presented. Display screen 269 may include the video 270 of the selected program that is being played back to the user and options 271 for controlling the video. Options 271 may, for example, include options that allow the user to rewind the video to the beginning, to rewind or reverse the video, to play the video, to fast-forward the video, to pause the video, or to stop the video. Control of these functions and other interactive television application functions may be supported using on-screen options, dedicated or multi-purpose keys on remote control 72 or other user devices, or other suitable arrangements involving user interface 118. When on-screen options are used, the options may be displayed in the form of one or more overlays on top of video 270 or video 270 may be provided in a reduced-size window and the options displayed outside of this window.

With the arrangement of FIGS. 20 and 21, the user can browse the user's recordings and can play back (and control the playback) of these recordings. Recordings that are stored locally on user equipment 18 may be played back by retrieving these recordings from the local hard drive or other storage on which the recordings are maintained. Recordings that are stored on the network may be played back from the network equipment on which the recording content is stored. User equipment 18 may receive such content in the form of a real-time video stream or a file download and the interactive television application may play back the received content using a display screen arrangement of the type shown in FIG. 21.

The user may record programming by indicating interest in a program for recording by highlighting a program of interest on a suitable display screen provided by the interactive television application and pressing a record key, by selecting a program for recording from a flip or browse display, by tuning to a desired program and selecting an appropriate record button, by selecting a record option from an information screen, etc. For example, the user may highlight a program in a program listings screen such as screen 138 of FIG. 8, or may display a program listing of interest on a flip display such as flip display 153 of FIG. 9 or on a browse display such as browse display 160 of FIG. 10. When the user presses a suitable remote control key such as record key 86 of FIG. 4, the interactive television application may record the desired program.

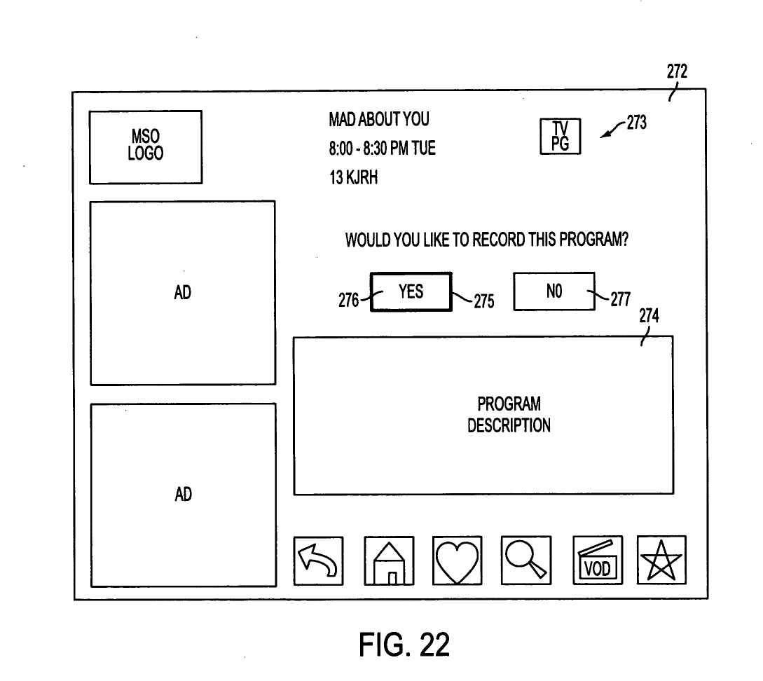

The interactive television application may automatically record the program that the user selected or may provide one or more additional confirmation and information screens after the user presses the record key 86. As an example, the interactive television application may display a screen such as record set-up screen 272 of FIG. 22. As shown in FIG. 22, screen 272 may include title and ratings information in region 273 and a program description 274. The user may be provided with information on the scheduled broadcast time for the selected program. If the user desires to record the program, the user may position highlight region 275 on top of YES option 276 and may press OK key 84. If the user does not wish to record the program, the user may position highlight 275 on top of NO option 277 and may press the OK key 84. If desired, other options such as series recording options, recording quality options, and buffer time options may be provided.

When the user directs the interactive television application to record a given program, the interactive television application will record the program using the local capabilities of user equipment 18 or using the network-based video recorder capabilities of the system 10, depending on the equipment of the user, the capabilities of system 10, and system and user settings.

After the program has been recorded, the user may use the interactive television application to view information on the user's recordings (e.g., using a display screen arrangement of the type shown in FIG. 20). These techniques for supporting recording functionality in the interactive television application are merely illustrative. Any suitable arrangement for recording (as real recordings or as virtual recordings and locally or on network equipment) may be used if desired.

The interactive television application may allow the user to establish parental control settings. For example, the user may lock a particular program, a program rating, a channel, a type of content (e.g., violent or sexual content), or may establish a parental control setting that blocks all television viewing during a particular period of time. A user may be required to enter a personal identification number (PIN) to unlock blocked content.

With one illustrative arrangement, a parent (or other suitable user) may select a program to block by highlighting the program listing for that program in a suitable program listings screen (e.g., a screen such as screen 138 of FIG. 8). After highlighting the program to be blocked, the parent may press lock key 92 on remote control 72 (FIG. 4). The parent may also access options for setting parental locks by selecting an on-screen parental control lock option provided by the interactive television application (e.g., option 234 of FIG. 17a, option 244 of FIG. 17b, etc.).

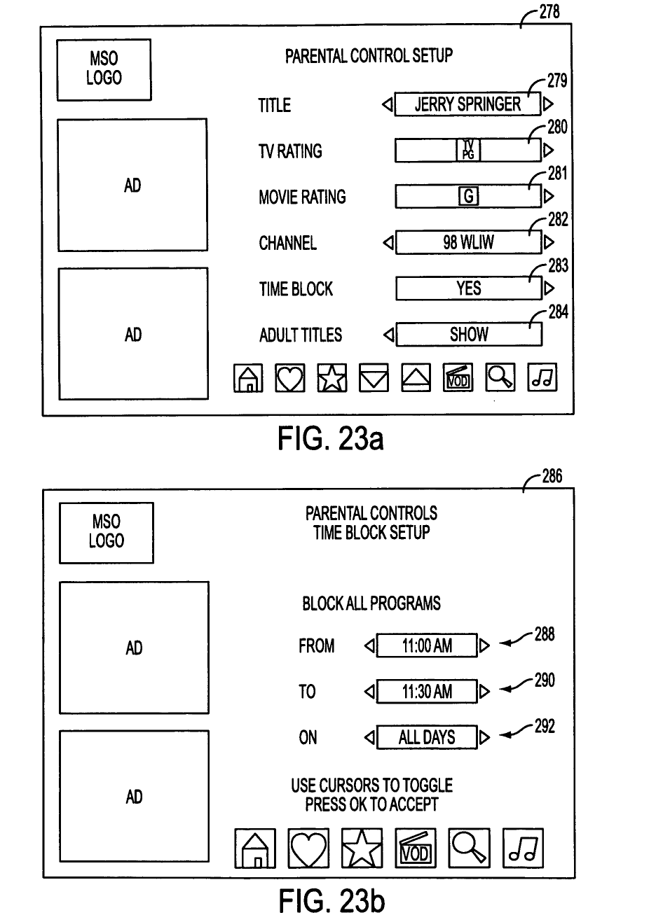

In response to a user selecting an on-screen option or remote control key to access parental control lock options, the interactive television application may display a display screen such as parental controls display screen 278 of FIG. 23a. Parental controls options may be accessed from a main menu, a selected program, or any other suitable program guide screen. Users may set parental locks for a selected program or a range of programming by selecting from various criteria. For example, users may select to block programs according to title 279, TV rating 280, movie rating 281, channel 282, or any other suitable criteria. Block ratings options 280 and 281 may allow users to block all programming with a given rating (e.g., the same rating as the selected program or a user-input rating or range of ratings). The user may be provided with other options for applying parental lock settings by selecting, for example, (YES/NO) time lock option 283. A user may also select to hide or show adult titles by selecting option 284. Other selectable options may also be provided in screen 278.

If the user has selected “YES” for time block option 183, a time block sub-menu may be provided, for example, screen 286 of FIG. 23b. The user may use the on-screen options of screen 286 to set a beginning time (option 288) and ending time (option 290) for the parental control time period. The user may use option 292 to make the parental control setting effective for all days of the week, certain groups of days (e.g., week days or weekend days), or a particular day or days. The user may press OK key 84 when finished. Other selectable options may also be provided as part of screen 286.

The parental control screens 278 and 286 of FIGS. 23a and 23b are merely illustrative. Any suitable on-screen options or other user interface arrangement may be used to allow a parent (or other user) to block (parentally-control) programming airing during a particular period of time, programming on a particular channel or channels, programming with a certain rating, individual instances of certain programs, etc.

Media-on-demand services (e.g., video-on-demand or audio-on-demand services) are services wherein a user may request and subsequently receive media content essentially in real-time (e.g. within seconds or minutes of the request). After a user requests a media-on-demand program, a stream of video or audio may be delivered to the user equipment for viewing or listening. This stream may be buffered and/or stored to improve performance (e.g., presentation of the media stream to the user without interruption or pausing).

In contrast, a user ordering a pay-per-view (PPV) program may only view the program at scheduled times, and not on-demand. Placing an order for PPV content either before or after the scheduled time means that the user may have to wait until the scheduled time, or view a program already in progress. When a user orders a PPV program, the system may unlock for a limited time a previously unviewable (e.g., scrambled) channel on which the PPV program is being shown, thereby allowing the user to view the program.

Video-on-demand programming may be branded or sponsored by one or more different vendors, such as television networks or cable channels (e.g., Starz, Showtime, HBO, etc.). The content itself is generally stored on servers such as server 56 or server 36, and is delivered to the users by the users' television distribution facility 14 (operated by the user's service provider), but the vendor may select the content to be offered and may have rights in the content. Each vendor may provide a different and/or exclusive selection of video-on-demand content than the other vendors. The large number of video-on-demand programs that may be available from all of these vendors may make it difficult for the user to find and/or select a program that he/she may interested in among all of the programs and categories of video-on-demand programs listed in the program guide menus.

As shown in FIGS. 14 and 15, the interactive television program guide may allow the user select a video-on-demand program by displaying one or menus screens that list available programs or categories of programs. Each category or program may be represented in a menu as a user-selectable option. In response to the user selecting the category option, the interactive television program guide application may display subcategory menus, such as those depicted in FIGS. 15 and 16, which may display programs or additional subcategories in a similar manner. In response to the user selecting a video-on-demand program in the menu, the interactive television program guide application may display information associated with the video-on-demand program to the user, information or instructions on ordering the program, begin presentation of the program, allow viewing of a preview associated with the program, or any suitable combination thereof. The program guide may also allow the user to search for available programs, or allow browsing of programs by program, genre, actors, directors, vendors, or any other suitable criterion.

If there is a large number of available video-on-demand programs, the user may have difficulty in finding a program of interest. The interactive television program guide may attempt to alleviate this difficulty by increasing subcategorization of the programs, such that each subcategory menu contains a manageable number of programs. In some embodiments, the program guide may also allow the user to navigate between subcategory menus in a manner that reflects a hierarchical and/or logical relationship, thereby assisting the user in eventually finding a video-on-demand program of interest. However, an increasing number of subcategories and menus may not reduce the user's difficulty.

In another suitable approach, the interactive television program guide application may provide the user with a reduced or limited list of titles and categories to choose from, or a list of titles and categories that the user is more likely to choose from. This list may be reduced to a subset that is more likely to be reflective of the user's particular interests, thereby increasing the likelihood of the user finding a program or category of interest in this list. In addition, the program guide may provide the user with one or more customized menus that displays these titles or categories of interest as selectable options, similar to those shown in FIGS. 14-16. Therefore, when a user is navigating or browsing through these customized video-on-demand menus displayed by the program guide, the user is more likely to find and subsequently request delivery of a video-on-demand program.

The program guide or other interactive television application may use a user's personal profile to determine possible programs and categories of interest. The user's personal profile may be associated with a particular user, and includes data and information about that user. The personal profile may include, for example, demographic information (e.g., age, gender, income, race, marital status), interests (e.g., relating to products, services, programming content, hobbies, etc.) for which the user has expressed or indicated an interest, preferences (e.g., relating to products, services, programming content, hobbies, etc.) for which the user has expressed or indicated favor or disfavor, viewing habits (e.g., what, when and how often the user watches television, movies, video-on-demand, certain television channels, etc.), program guide actions (tabulation and/or statistics regarding the users interactions with the program guide, such as requesting information, ordering a product or service, recording programs, adding an item to a favorites list, etc.), a consumer profile (products, services, and media content that the user has previously ordered or for which the user has requested information), or any other suitable information. A user's personal profile may include any data or information that is reflective of the user and may also differentiate that user from other users.

A user's personal profile may be generated from data and information that is or has been collected or gathered directly, indirectly, or a combination of both. Direct collecting or gathering of data and information may include approaches such as, for example, on-line surveys (e.g., through a website), program guide surveys, off-line surveys (e.g., by telephone, by door-to-door, or by mail), user-configured preferences in the program guide, credit reports, public and private databases and records, search engines, or mailing and subscription lists. However, any other suitable approach for collecting or gathering data and information may also be used. For example, another approach for collecting or gathering information is prompting or allowing the user to indicate their like or dislike for certain programs, services, media, etc. Such indications may be binary (e.g., yes/no, like/dislike, etc.) or be based on a continuous scale with appropriate gradations. Direct collecting or gathering approaches may involve collecting or gathering data and information actively from the user or from another source.

In some embodiments, indirect approaches for collecting or gathering data and information may also be used. Indirect methods may include, for example, recording, observing, or other forms of acquiring and compiling information about the user based on their actions or habits. Indirect approaches may not involve direct queries to the user or other sources of information, but may involve making determinations and/or inferences based on the user's actions and, or in combination with, determinations based on directly collected or gathered data or information. For example, the interactive television program guide application may keep track of the television programs and other media content that the user watches, records, skips, orders, pauses, deletes, sets reminders for, etc. From this data, the program guide may determine the user's interests with respect to, for example, genres, actors, channels, themes, timeslots, etc. These indirect methods may involve collecting or gathering data or information relating to the user in a passive or observational manner. In addition, or alternatively, indirect methods may also include determining information about the user from existing data.

A personal profile may be generated from the data and information collected or gathered by the foregoing direct and indirect approaches. The profile may also include categories into which the user is classified, such as demographic categories. These categories may be more useful for later use and comparison than the specific data. For example, a user's profile may include information that the user is in the 18-35 year-old age group and a sports fan, instead of or in addition to the more specific information that the user is 27 years old and a New York Mets and a Boston Bruins fan. Personal profiles may be generated and updated using a combination of these and other suitable approaches.

Personal profiles may be stored in memory or other storage on local user equipment, such as a set-top box. The personal profile may also be stored on network equipment, such as a remote server. The interactive television application implemented on the local user equipment may be configured to create, access and modify personal profiles either stored on the user equipment and/or remote equipment. In a system with a plurality of user equipment connected to a network, personal profiles stored on network equipment or user equipment may be accessible from more than one of the plurality of user equipment. For example, a user's personal profile may be created on his/her home user equipment. This personal profile may then be stored on the home user equipment or the network equipment. Accordingly, even if the user is using different user equipment, the system may allow the user to direct the local user equipment or the local interactive application to access the user's personal profile remotely for local customization.

In some embodiments, multiple personal profiles may be created for a single user. Such a feature may be useful if, for example, the user has differing moods that result in different interests. In another example, a given user may have a different personal profile for different days of the week, or different times of the day. In some embodiments, the personal profile may also include time, mood, or other conditional or modifying factors as part of the personal profile. The profile may be selected by the user, or may be automatically selected by the interactive television program guide application. For example, the interactive television program guide application may automatically select the last selected user profile. In another example, the interactive television program guide application may determine the time of day and select the user profile that has been most frequently selected by the user at that time of day.

If there are multiple users that are able to use a given user equipment, each user may have a personal profile. Each profile may be protected or otherwise access-restricted by a user-specific password. For example, the interactive television program guide may prompt the user by, for example, inputting a login or personal identification number (PIN), or by pressing a button assigned to them. Accordingly, the interactive television program guide may then use that user's personal profile to generate the customized menus. The interactive television program guide may also use a combination of profiles at the same time, for example, if multiple household members are viewing the television at the same time. In some embodiments, profiles may be created to reflect the interests of a group of people, such as a family. In other suitable embodiments, a personal profile for a child or a minor may include parental lockouts or other restrictions that are not changeable by the minor. For example, the interactive television application may require that parental lockouts or restrictions for a child's personal profile may only be modified using the account or profile of the parent. In this embodiment, a minor's profile may exclude certain programs and/or categories that would otherwise be displayed for an adult with a similar personal profile.

In some embodiments, the interactive television program guide application may use the user's personal profile to determine or generate a list of video-on-demand programs and categories that may be of interest to the user. This may be performed on the local user equipment or at a remote server.

In either location, several approaches may be used to determine a list of programs and categories of programs based on a user's personal profile. In one suitable approach, a video-on-demand program or category (or groups of programs or categories) may be associated with attributes relating to the program and category. Suitable attributes may include, for example, genre, parental rating, actors, directors, critics' ratings, etc. A program or category may also include personal profile attributes such as, for example, age, gender, income, marital status, programming likes and dislikes, viewing habits, etc. These personal profile attributes may relate to the type of person known or predicted to be interested in that program or category. Any suitable number or combination of these attributes may be associated with a program or a category.

The user's personal profile may be compared to these attributes to determine the best or closest program and/or category. A certain fraction of the best or closest matches may then be used to generate or add to a list that reflects the user's interests. For example, a certain video-on-demand movie may include attributes indicating that users who are science-fiction fans, have a high-income, are single-women between 30-40 years of age, and/or watch NBC on Wednesday evenings are likely to be interested in the program. If a user's personal profile is shown to have a high correlation to these attributes (i.e., they match one or more of these attributes), the program may be added to the list of programs that may be of interest to the user. Groups of similar or related programs or categories may be given a group attribute, such that a high correlation to a user's personal profile may add the entire group the user's list. Negative correlation, conversely, may result in exclusion or removal of programs and categories.

In another suitable approach, the user's likes and dislikes in the personal profile may be used to generate or add to the list. For example, if a user's profile includes information that the user has a particular like for a specific video-on-demand movie or genre, the application may include similar movies or genres to the user's list. Conversely, an indication of a dislike may filter or remove titles or categories from the user's list, or prevent their addition to the list.

In yet another suitable approach, correlations between one user's profile to another user's profile may be used. For example, if a first user having a profile is associated with a list of programs or categories of interest, and a second user's profile closely matches or correlates to the profile of the first user, the application may add the first user's programs and categories to the second user's list. In this manner, a user's list of programs of interest may be generated indirectly through other users. Similarly, such correlations may be made between the programs and categories. For example, a database may contain correlations between different programs and categories, such that a strong like or preference for one indicates a likely interest in other programs or categories, which may then be added to the user's list.

The foregoing approaches for generating or determining a user's list of programs and categories of interest based on the user's personal profile are exemplary, and may be used singly or in any suitable combination thereof. Other suitable approaches for generating a list may be used by those skilled in the art. Moreover, a user's list of programs and categories of interest may be re-generated at future intervals (e.g., at a predetermined time), thereby generating a new list. This re-generation ensures that the list reflects the user's current interests if there have been changes to the personal profile. The regeneration may also ensure that newly available programs and categories are considered for inclusion (or conversely, unavailable programs and categories may be removed) to ensure the list reflects currently available titles and categories.

Once a user's list of video-on-demand programs and categories based on his/her personal profile has been determined, the interactive television program guide application may generate and display customized video-on-demand displays. These customized displays may contain menus listing programs and/or categories based on the user's interest list. In this manner, the interactive television program guide application may provide the user with a menu containing programs and/or categories that may be reflective of the user's interests, thereby increasing the likelihood that the user may find and request a video-on-demand program for viewing. In some embodiments, the user may need to indicate or notify their identity to the interactive television program guide application, for example, by inputting a login and password or by inputting a PIN number. In some embodiments, the interactive television program guide application may provide multiple menu options or assign different key presses, such that each menu option or key press represents a different profile. By selecting an option or by pressing a key, the interactive television program guide application may display the customized video-on-demand menu associated with the profile represented by the selected option or key press. In some embodiments, the program guide may not require logging in. For example, the program guide application may maintain a single profile for the entire household or a subgroup thereof, and may select that profile automatically. Once the user is identified by the application, the interactive television program guide application may use that user's personal profile to generate and display customized video-on-demand menus reflective of that user's personal profile.

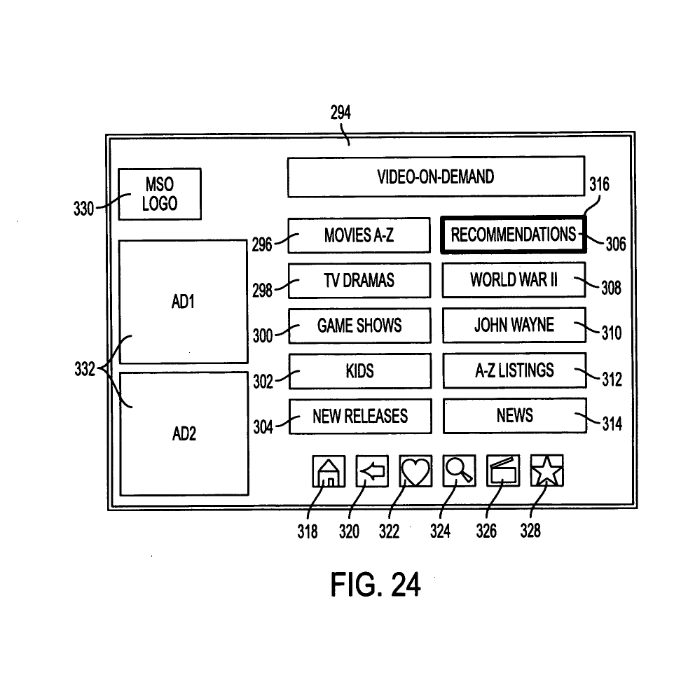

Referring to FIG. 24, an illustrative screen displayed by an interactive program guide is shown. Screen 294 is an illustrative video-on-demand main menu that includes user selectable options 296-314, of which one or more (e.g., all) are customized based on the user's interests and personal profile. A user may select any of these options by positioning highlight 316 on an option and pressing “OK” on a remote control or other input device. Screen 294 also includes navigational options 318-328 which, when selected by the user, direct the interactive television program guide application to display another menu, or to display additional options. Screen 294 also may include an MSO logo 330 and advertisements 332. Advertisements 332 may be selectable by the user or otherwise interactive, allowing the user to, for example, request additional information about the subject of the advertisement, or purchase or order the subject of the advertisement. As in any display screen described, screen 294 may also include a number of graphics, animations, selectable advertisements, video windows, or any other suitable content.

In screen 294, the user-selectable options may include video-on-demand programs and/or categories that are displayed for every user. These options may also include programs and categories that are determined by the user's list of interests (based on the user's personal profile). The interactive television program guide application may be configured to display options 296-304 for every user irrespective of their personal profile. For example, the interactive television program guide application may provide every user with a “Most Popular” option that provides users with a list of video-on-demand programs that are most frequently ordered. In some embodiments, options 308 and 310, for example, may be video-on-demand content categories that are reflective of the user's interests. In this example, the user's personal profile may have indicated or correlated with an interest in video-on-demand programming with World War II themes or subject matter, as well as content about or featuring the actor John Wayne. A different user with a different personal profile may have different categories listed in their corresponding options.

The number of options in screen 294 or any other customized video-on-demand menu that are determined by the user's interest list may be fixed for each screen, may be configured by the user, or may dynamically change or evolve based on the user's actions. In addition, since a user's personal profile may continually evolve or change based on additional information from or input by the user or other sources, these customized menus may serve as feedback to refine the profile and/or the list of user interests. For example, the interactive television program guide application, based on the user's profile, may determine that the user is interested in John Wayne and may, in response, display option 310. The interactive television program guide application may also monitor the number of times that the user selects this option. After a predetermined amount of time (e.g., one week, one month, etc.), the failure of the user to select this option may indicate that the user's interest in John Wayne movies may have been an incorrect determination or a false positive, or that the user's interest may have changed. In response to the user not selecting this option after a predetermined amount of time, the interactive television program guide application may downgrade or remove this category from the user's list. Conversely, in response to the user frequently selecting option 310 may indicate that this prediction was accurate or reflective of the user's interest. The user's profile may be updated accordingly to reflect this information.

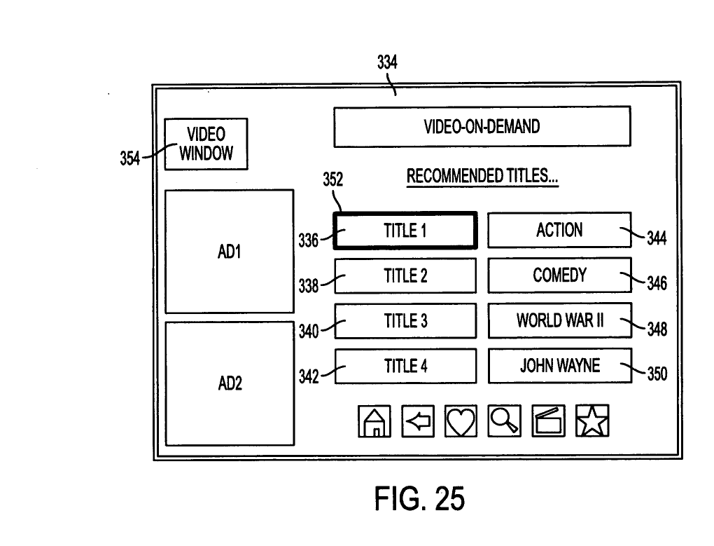

In screen 294, the user may select a “Recommendations” option 306 by, for example, highlighting option 206 using highlight 316 and selecting option 206 using the remote control. In response to the user selecting option 206, the interactive television program guide application may display an illustrative recommendation screen 334 as shown in FIG. 25. Screen 334 may include selectable options 336-342 associated with video-on-demand programs that were selected based on the user's personal profile. A user with a different personal profile and interests may see a different list of programs. Screen 334 may also include options 348 and 350 that are associated with customized video-on-demand categories. The categories may also be based on the user's personal profile. Options 344 and 346 may be consistent between users, displaying generic video-on-demand categories in addition to the other customized categories.

Screen 334 may also include a video window 354. In video window 354, information, advertising, previews, or any other suitable content relating to available video-on-demand content may be displayed therein. For example, the program guide application may display pictures, animation, videos, or the like in video window 354. A user may highlight an option, such as option 336 (“Title 1”), which may direct the interactive television program guide application to display additional information relating to “Title 1” in video window 354. In some embodiments, the program guide application may also require additional action, such as pressing an “INFO” button on the user remote control, before displaying such information.

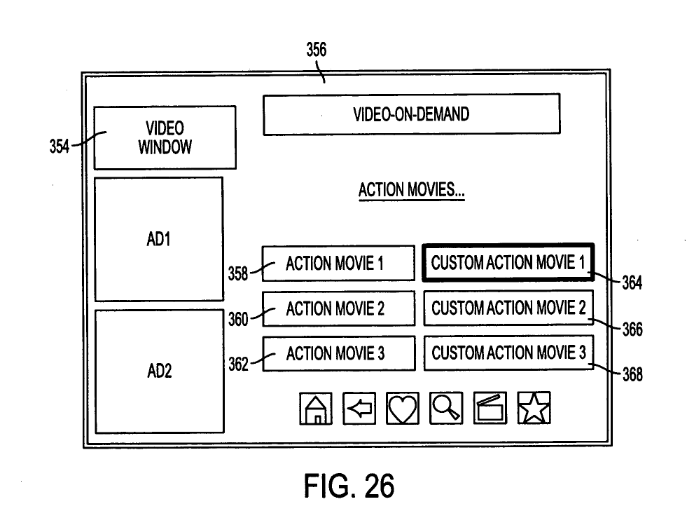

In response to the user selecting a category option in a video-on-demand menu, such as an “Action” option 344 on screen 334, the program guide application may display a genre menu screen, such as an illustrative “Action” menu screen 356 shown in FIG. 26. Option 344 may or may not be a customized option. Genre menu screen 356 may also be a customized video-on-demand menu that displays programs that are not based on a user profile, such as options 358-362, and programs that are based on the user's profile, such as options 364-368. As shown in screen 356, a customized video-on-demand menu may display both user profile-based and non-user profiled-based programs and categories.

In order to generate customized video-on-demand menus, one or more menu interface templates may be used. A menu interface template is a template in which interface elements or option labels, such as video-on-demand programs and categories, are initially absent. An application, such as the interactive television program guide application implemented on the user equipment and/or a similar application on a remote server, may incorporate the titles of programs and categories into some or all of the absent interface elements or labels. Once these labels or elements are incorporated, the completed menu screen may be displayed by the interactive television program guide application.

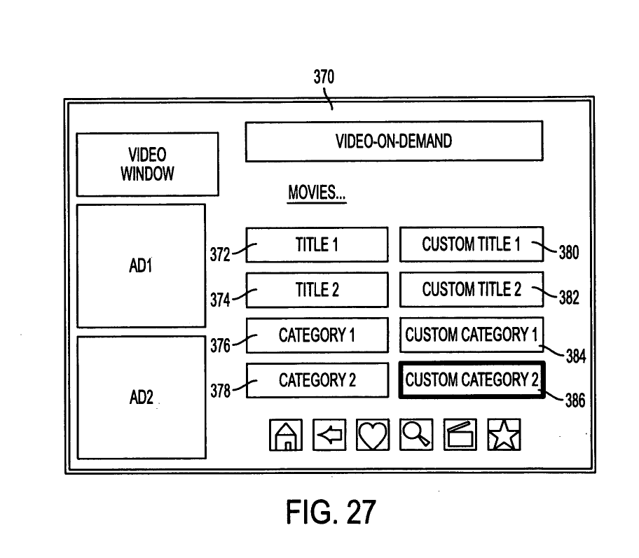

FIG. 27 shows an illustrative template for a customized video-on-demand template in accordance with various embodiments of the present invention. Template 370 may include options 372 and 374 that may be placeholders for video-on-demand programs and options 376 and 378 that may be placeholders for video-on-demand categories. Options 372-378 may be customized with programs and/or categories that appear for all users regardless of their personal profile. It should be noted that these programs and/or categories may change at a predetermined time (e.g., periodically) and the labels for these options may be absent in the template. Multiple menu template may also be used if available, if more than one customized video-on-demand menu is desired for display.

Template screen 370 may also include options 380 and 382 that may be placeholders for video-on-demand programs that are based on the user's personal profile. Similarly, options 384 and 386 may be labeled with video-on-demand categories that may also be of interest to the user based on his/her personal profile.

Template menu screen 370 may be stored on the user equipment (in memory or other storage) or a remote server to which a plurality of user equipment may communicate and transfer information. When the template menu screen is stored on a remote server, an application on the server may incorporate programs and categories for labeling user-selectable options 372-378, such that these programs and categories may appear in the menu screen for all users. In addition, the application may also incorporate programs and categories for labeling user-selectable options 380-386, where these programs and categories are based on the user's personal profile. Accordingly, information regarding the specific user for which the menu template was customized may also be included in the customized menu, such that the customized menu may be delivered to or retrieved by the interactive television program guide application on the user equipment being used by that specific user. In order for the remote application to incorporate user-specific information, the application may need access to the user's personal profile and/or the user's list of video-on-demand programs and categories of interest.

Alternatively, template 370 may be provided to or stored on the user's local user equipment. In this case, the locally-implemented interactive television program guide application may incorporate the programs and categories in options 380-386 on the template, wherein the programs and categories are based on the user's personal profile. The application may then display this user-customized menu for the user within the program guide. This approach may be preferable in circumstances in which it is desirable that the user's personal profile or interests not be revealed or communicated outside of the user's local equipment.

Once a user-customized video-on demand menu has been generated, the customized menu may be stored on the user equipment for re-use, or regenerated occasionally to incorporate new programs and categories. This regeneration may ensure that customized menus are up-to-date with respect to the user's personal profile and available programs and categories, or may simply allow changing of the programs and categories of interest to others that have not been previously listed.

Personal profiles may be used to customize video-on-demand display screens of the present invention in other suitable approaches. For example, a user's personal profile may also be used to determine the listing order, appearance, and other displayed attributes of the programs and categories that appear in the menu screens. Referring to screen 334 of FIG. 25 as an example, the listing order of the programs may also be based on the user's profile. For example, selectable option 336 (“Title 1”) may list the program that is determined to be of most interest to the user. Such a determination may be made, for example, by identifying the program having attributes with the highest correlation to the user's personal profile. Similarly, the programs that appear in options 336-342 may be sorted and listed in order of descending correlation to the personal profile, or other suitable comparative criteria. This ordering of the listed programs and categories may also be limited to programs and categories selected based on the user's personal profile. By sorting and ordering the listing in these exemplary manners, the program that may be of highest interest to the user is positioned in a prominent and easily selectable location.

Alternatively, or in addition to the listing order feature, the visual appearance of the listed programs and categories may also be based on the user's personal profile. Examples of visual appearance attributes include color, pattern, size, font properties, and suitable combinations thereof. For example, if particular programs or categories are determined to have a high likelihood of interest to the user, the selectable options that correspond to those titles and categories may displayed in a more visually prominent or distinguishable manner (e.g., a different color, background pattern, font size or type, option size, and the like). The interactive television application may also display the selectable options in accordance with a visual scale (e.g., a color spectrum, degrees of shading, etc.) such that the scale is indicative of the predicted degree of interest to the user. Adjusting the visual attributes of the programs and categories displayed in the menu screens of the present invention may also allow the user to quickly assess and identify those that are likely to be of particular interest.

These features of sorting, ordering, or otherwise visually distinguishing or organizing the programs and categories based on the user's personal profile may be performed without first selecting or identifying programs based on the personal profile. For example, the system may display a list of “New Releases” to the user which contains all of the new and recently released programs. Since not all of these programs may be of interest to the user, the list of programs may be sorted and listed in an order or arrangement based on, e.g., the degree of correlation to the user's personal profile. When this ordered listing is displayed for the user, the user's attention may be drawn to those programs that have been determined to be of highest interest to him based on his personal profile. Other programs of lesser interest, such as those that do not match the personal profile or match the user's dislikes, may still be displayed. These programs may be displayed in a less prominent position, such as at the bottom of a list.

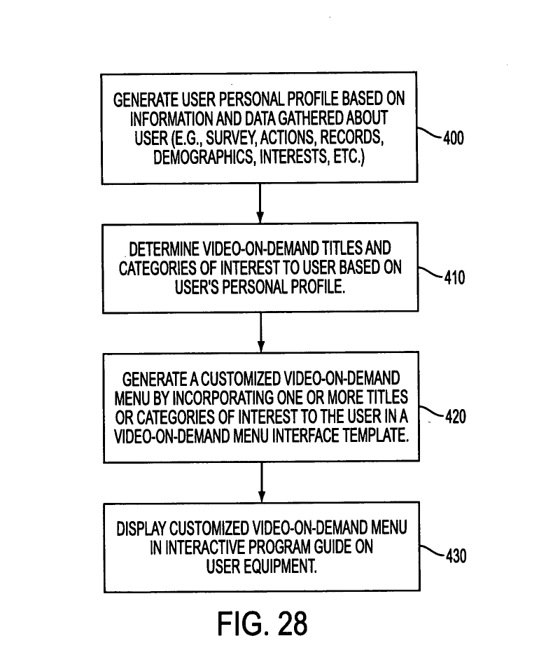

FIG. 28 shows an illustrative method for generating a customized video-on-demand menu based on a user's personal profile and interests in accordance with various embodiments of the present invention. At step 400, a personal profile is generated for a given user. This personal profile, as described in detail above, may include and incorporate information and data collected or gathered by survey, recording user actions, available records, demographics, user interests, etc. Once generated, the personal profile may be used and accessed by, for example, an interactive television application when the user identifies him/herself by a login/password or personal identification number (PIN), or using other suitable means. The interactive television application may generate (in the following step) a menu that may be customized for the identified user.

At step 410, an application (either on the user equipment or the remote server) may use the user's personal profile to personalize the content of the video-on-demand menu that is displayed for the user. For example, the application may determine which selectable on-screen options to display for the user, may determine which advertisements to target for the user, etc. The application may determine a list of video-on-demand program titles and/or categories that may be of interest to the specific user that are drawn from a list of available programs and categories. Such determinations may be made, for example, by correlating the user's profile to attributes associated with programs, categories, or groups thereof. In addition, a list of interests for a first user may also be determined by correlating the personal profile of the first user with that of a second user (or group of users), and adding or rejecting programs and categories in the first user's list from the second user's list according to the correlation. In yet another suitable approach, programs and categories may also be added or removed to a user's list based on correlations to programs and categories already present on the user's list of interests.

At step 420, an application may incorporate one or more program titles and/or categories from a user's list into placeholders in a video-on-demand menu interface template. This incorporation results in a user customized video-on-demand menu that is suitable for display. More than one template may be used if appropriate. Once a customized menu has been generated, the menu may be stored for re-use, and/or regenerated occasionally to ensure it is up-to-date with respect to the user's personal profile and available programs, or to simply change the programs of interest.

At step 430, the customized video-on-demand menu is displayed in an interactive program guide on the user equipment. In a manner similar to interface screens described herein, displaying this screen allows the user to select a program or category option. In response to the user selecting a program or category, the interactive television program guide application may display another menu screen, or begin delivery of the video-on-demand program.

Thus, systems and methods for providing customizable video-on-demand menus based on a user's personal profile are provided. One skilled in the art will appreciate that the present invention can be practiced by other than the described embodiments, which are presented for purposes of illustration and not of limitation, and the present invention is limited only by the claims which follow.

1. A method of providing a user with media-on-demand programming using an interactive television application implemented on user equipment, the method comprising:
generating a personal profile based on collected information relating to the user;
determining a media-on-demand program for the user based at least in part on the personal profile;
generating a customized media-on-demand display by incorporating the media-on-demand program into an interface template; and
displaying the customized media-on-demand display to the user.

2. The method of claim 1, wherein the generating the personal profile comprises collecting demographic information about the user.

3. The method of claim 1, wherein the generating the personal profile comprises collecting information about the user's interests.

4. The method of claim 1, wherein the generating the personal profile comprises collecting information about the user's viewing habits.

5. The method of claim 1, wherein the generating the personal profile comprises collecting information about the user's interactions with the interactive television application.

6. The method of claim 1, wherein the determining the media-on-demand program comprises correlating the personal profile of the user with a second personal profile of a second user.

7. The method of claim 1, wherein the determining the media-on-demand program comprises comparing attributes of the media-on-demand program with the personal profile.

8. The method of claim 1 further comprising storing the personal profile on the user equipment.

9. The method of claim 1 further comprising modifying the personal profile based on the user's interactions with the customized media-on-demand display.

10. User equipment for providing a user with media-on-demand programming using an interactive television application implemented on the user equipment, the user equipment comprising:
a display;
control circuitry configured to:
generate a personal profile based on collected information relating to the user;
determine a media-on-demand program for the user based at least in part on the personal profile;
generate a customized media-on-demand display by incorporating the media-on-demand program into an interface template; and
display the customized media-on-demand display to the user.

11. The user equipment of claim 10, wherein the collected information comprises demographic information about the user.

12. The user equipment of claim 10, wherein the collected information comprises information about the user's interests.

13. The user equipment of claim 10, wherein the collected information comprises information about the user's viewing habits.

14. The user equipment of claim 10, wherein the collected information comprises information about the user's interactions with the interactive television application.

15. The user equipment of claim 10, wherein the control circuitry, when configured to determine the media-on-demand program for the user, is configured to correlate the personal profile of the user with a second personal profile of a second user.

16. The user equipment of claim 10, wherein the control circuitry, when configured to determine the media-on-demand program for the user, is configured to compare attributes of the media-on-demand program with the personal profile.

17. The user equipment of claim 10, wherein the control circuitry is further configured to store the personal profile on the user equipment.

18. The user equipment of claim 10, wherein the control circuitry is further configured to modify the personal profile based on the user's interactions with the customized media-on-demand display.

19. A system for providing a user with media-on-demand programming using an interactive television application implemented on the user equipment, the system comprising:
means for generating a personal profile based on collected information relating to the user;
means for determining a media-on-demand program for the user based at least in part on the personal profile;
means for generating a customized media-on-demand display by incorporating the media-on-demand program into an interface template; and
means for displaying the customized media-on-demand display to the user.

20. The system of claim 19, wherein the collected information comprises demographic information about the user.

21. The system of claim 19, wherein the collected information comprises information about the user's interests.

22. The system of claim 19, wherein the collected information comprises information about the user's viewing habits.

23. The system of claim 19, wherein the collected information comprises information about the user's interactions with the interactive television application.

24. The system of claim 19, wherein the means for determining the media-on-demand program comprises means for correlating the personal profile of the user with a second personal profile of a second user.

25. The system of claim 19, wherein the means for determining the media-on-demand program comprises means for comparing attributes of the media-on-demand program with the personal profile.

26. The system of claim 19 further comprising means for storing the personal profile on the user equipment.

27. The system of claim 19 further comprising means for modifying the personal profile based on the user's interactions with the customized media-on-demand display.

28. Machine-readable media for use in an interactive television application implemented on user equipment, in which the interactive television application provides a user with media-on-demand programming, wherein the media is encoded with machine-readable instructions for performing the method comprising:
generating a personal profile based on collected information relating to the user;
determining a media-on-demand program for the user based at least in part on the personal profile;
generating a customized media-on-demand display by incorporating the media-on-demand program into an interface template; and
displaying the customized media-on-demand display to the user.

29. The machine-readable media of claim 28, wherein the generating the personal profile comprises collecting demographic information about the user.

30. The machine-readable media of claim 28, wherein the generating the user personal profile comprises collecting information about the user's interests.

31. The machine-readable media of claim 28, wherein the generating the personal profile comprises collecting information about the user's viewing habits.

32. The machine-readable media of claim 28, wherein the generating the personal profile comprises collecting information about the user's interactions with the interactive television application.

33. The machine-readable media of claim 28, wherein the determining the media-on-demand comprises correlating the personal profile of the user with a second personal profile of a second user.

34. The machine-readable media of claim 28, wherein the determining the media-on-demand program comprises comparing attributes of the media-on-demand program with the personal profile.

35. The machine-readable media of claim 28 further comprising storing the personal profile on the user equipment.

36. The machine-readable media of claim 28 further comprising modifying the user personal profile based on the user's interactions with the customized media-on-demand display.
